(19) United States
(12) Patent Application Publication
(10) Pub. No.: US 2012/0232939 A1
(43) Pub. Date: Sep. 13, 2012

(54) Method for Rendering Layer Images and Providing Information

(75) Inventors: Lester S. Pierre, Valley Cottage, NY (US); Nader Ali Chouman, Lodi, NJ (US); Alexander Olegovich Khaykin, Lodi, NJ (US); Manimaran Manimaran, Piscataway, NJ (US); Asim Masood, Scotch Plains, NJ (US); Michael J. Russo, Staten Island, NY (US)

(73) Assignee: Xtreme GIS, Inc.

(21) Appl. No.: 13/471,836

(22) Filed: May 15, 2012

Related U.S. Application Data
(62) Division of application No. 12/641,128, filed on Dec. 17, 2009.

(51) Int. Cl. G06Q 40/08

(52) U.S. Cl. 705/4

(57) ABSTRACT

A User Interactive Insurance Risk Analysis Application that is web-based which combines user imported insurance portfolios and geospatial technology with output from user defined actions and simulations providing an analysis tool for dynamic management of catastrophic exposures. The user may configure every aspect of the risk analysis application and use a variety of tools and features to create actions and receive risk information of all layers used for analysis. Precise risk information is given to the user due to the many services and modules which make up the risk analysis application, including a loss calculation service and dynamic, multi-dimensional configurable risk data display. The user receives estimated loss values and may configure which pieces of data analysis the user would like to see and how that data is presented without having to drilldown through all the data in the insurance portfolio.

### CROSS-REFERENCE TO RELATED APPLICATION

This application is a divisional of U.S. patent application Ser. No. 12/641,128 filed Dec. 17, 2009, now pending. The patent application identified above is incorporated herein by reference in its entirety to provide continuity of disclosure.

### BACKGROUND OF THE INVENTION

1. Field of the Invention

Insurance companies provide protection for a variety or risks. These risks include hazardous weather, injury, vehicle accidents, etc. Reinsurance companies provide protection, or insurance, to insurance companies against the risk of these losses.

Reinsurance companies use a variety of services in order to estimate losses which they may incur. These reinsurance companies utilize existing applications which calculate losses in a variety of ways. However, an application which is user interactive in all aspects is not in existence. The applications which exist in the prior art are static; the information given is what the user receives. The present invention is dynamic in all aspects.

The existing risk analysis applications in the industry do not allow the user the option to model an event based on historical data, real-time data, random data and, most importantly, user selected geographical model path and user manipulated variables of the model in a model simulation for its effect of loss on a user's portfolio. Furthermore, existing applications force the user to go through static data which may not always be needed, forcing the user to drill down and go through hundreds, if not thousands, of data in the order created by a developer of an application to obtain the desired piece of information. The present invention contains a dynamic, 360 degree dimensional method of data presentation which allows the user to drill down into the data by selecting, arranging, and rearranging the data in a way which allows the user to obtain exactly what is desired for specific analysis.

The present invention is a sophisticated application which can simulate virtually any catastrophic event causing loss. This application is the first of its kind in geospatial technology because of its ability to precisely calculate the total insurance value of a catastrophe affected area. A Loss Calculation Service accomplishes this by providing rapid computations of total values and average loss or risk due to disasters, providing a picture of projected losses.

2. Description of the Prior Art

There are other applications designed for risk analysis. Typical of these is U.S. Pat. No. 6,684,219 issued to Shaw on Jan. 27, 2004.

Another patent was issued to Kram on Jul. 5, 2005 as U.S. Pat. No. 6,915,211. Yet another U.S. Pat. No. 7,441,197 was issued to Tschiegg on Oct. 21, 2008.

A patent application was published for Hall on Dec. 11, 2003 as U.S. Patent Application Publication No. 20030229509. Another was published for Mathai on Aug. 30, 2007 as U.S. Patent Application Publication No. 20070203759 and yet another was published on Sep. 13, 2007 for Mathai as U.S. Patent Application Publication No. 20070214023. Still yet another U.S. Patent Application Publication No. 20090125359 was published for Knapic on May 14, 2009.

### SUMMARY OF THE PRESENT INVENTION

The present invention relates generally to map images and corresponding information and, more specifically, to a method for rendering map layer images and providing information for risk analysis to provide a comprehensive accumulation analysis tool in order for a user of such to manage business data and the effects of various events on that business data.

A primary object of the present invention is to provide a user interactive risk analysis application. Since the application is web-based, the application allows an insurance or reinsurance company to integrate the company's insurance portfolio into the application. Once the portfolio is integrated into the application, the user is able to map individual risk locations from all or a subset of the portfolio on an interactive map. This application allows the user to see, in advance, how their portfolios would be affected by any natural or man-made catastrophe. The user may summarize exposures by world, continent, country, state, county, zip code and risk; get specific information on any given risk by clicking on the location on the map; organize and categorize the portfolio by any physical characteristic of a risk (construction type, distance to feature, age, deductible, coverage A amount) or by operational characteristics of the risk (agent or underwriter); create ad-hoc deterministic models and see how they would impact the company's portfolio or any part of it; and estimate the impact on probable maximum loss (PML) of adding or removing risks from the portfolio.

Another object of the present invention is to provide a risk analysis application which allows the user to look at user's entire portfolio or a subset based on the criteria the user selects by providing a dynamic and user configurable multi-dimensional interactive data display. The criteria are based on the data fields which user supplies and loads into the application database. For example, user may filter, or organize, the data using a variety of factors including, but not limited to, zip code, distance to feature, construction, producer, agent, underwriter, class of business, total insured value (TIV) or average annual loss (AAL). By providing data in this way, the user is able to see the exact data that is desired, in a way that the user organized. Each risk location is represented on a user interactive worldwide map layer by a marking which is color coded based on each user's needs, such as TIV, AAL, line of business and type of business. The user may configure the line of business and type of business options to accurately represent the types of insurance that is offered by the specific company. The user is also able to format exposure concentrations by region.

Yet another object of the present invention is to provide a risk analysis application which allows the user to create deterministic model simulations. The application enables the configuration of any parameters of the model to better predict the type of risk for a particular claim. For example, user may create a tropical cyclone by drawing the storm track on the map or create an earthquake by selecting the location of the epicenter of an earthquake on the map in order to see how user's portfolio might respond to the created catastrophe. The application shows the user the exposure in damageability bands, for which user sets the damageability ratios within each band, for the event. User may also temporarily add or delete locations from an existing portfolio and see the impact on accumulations and simulated events.

Still yet another object of the present invention is to provide a risk analysis application with web based CAT modeling capabilities. The application components use a modular approach to overcome technology barriers for end user acceptance. The model simulations are based on unique combinations of scientifically accepted concepts and formulas which provides for more accurate risk analysis when compared to other risk analysis applications. The following models, not to be taken in a limiting sense, may be simulated: models associated with wind (tropical cyclone, severe weather wind, tornado), seismic (earthquake), pyrotechnic (wildfire, volcano, terrorism, fire following earthquake), hydro (flood, tsunami, ruptured dam), blast (terrorism, meteor, over pressure), environmental (air quality-terrorism, air quality-wildfire, nuclear radiation), falling debris (hail, volcano), and pilled debris (volcano ash, landslide).

Another object of the present invention is to provide a risk analysis application which allows the user to manage user's response to an actual catastrophe. The user is able to view maps of the physical characteristics of events such as wind speeds for hurricane, ground acceleration for earthquakes and area of burn in a wildfire. The application also shows before and after satellite images of an affected area. The user is able to accumulate exposures affected by an event as well as calculate rough loss estimates based on selected damage ratios or average loss per location.

Yet another object of the present invention is to provide a risk analysis application which provides various user interactive map layers and virtual three-dimensional user interactive map layers. In order for the user to obtain a better understating of the hazards around the portfolio, the application provides map layers which show terror targets; topographical features (fault lines, flood plains, soil conditions, elevations); weather related and environmental hazards; distance to the feature; historical events to obtain information such as hurricane tracks, tornadoes, epicenters of earthquakes; locations of modeling firm's events (which are landfalls for hurricanes and epicenters for earthquakes); demographic information such as housing stock, population, major cities; and geographical information such as elevation, major rivers, lakes, and highways.

Still yet another object of the present invention is to provide a risk analysis application utilizing the concept of Cloud Computing, allowing for one instance of the web based application software and having many customers using such application, so that each may use their own data and configuration, which is separated by the application software. Cloud Computing may include various application tiers following an N-tier architecture. The letter “N” signifies that the tier architecture may have any number of tiers, allowing for an application which is flexible, dynamic and capable of expansion. Of these application tiers, one is exposed to the internet, providing for the web-based application design. The concept of Cloud Computing as utilized in this application may also include offline software. This allows use of the application and the capability to work while disconnected from the internet.

Another object of the present invention is to allow importing of portfolio data into the application. The input and output of data follows the Association for Cooperative Operations Research and Development (ACORD) standards. While insurance companies following any standards may submit portfolio data, any ACORD compliant insurance company may submit data to the application with ease. Otherwise, insurance companies usually spend days to manually transmit risk information from one system to another.

The present invention overcomes the shortcomings of the prior art by providing a means for reinsurance and insurance companies to manage their catastrophic exposures in a way where the user dictates and controls the application. This application provides the user with user friendly, interactive and customizable features which optimizes the user's experience. The application is developed in such a way that a user with no insurance, reinsurance, or even risk knowledge is able to navigate through and utilize the application. Nowhere in the prior art exists an application in which the user can perform selections and model simulations with precise estimated loss values and configure exactly which pieces of analysis data the user would like to see and how that data is presented without having to drill down through all the data in a user's portfolio. Furthermore, combinations of processing approaches may be used in a Loss Calculation Service to provide a more intricate and detailed application to users.

The foregoing and other objects and advantages will appear from the description to follow. In the description reference is made to the accompanying drawings, which forms a part hereof, and in which is shown by way of illustration of specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is a chart outlining the Application Modules of the present invention;

FIG. 2 is a flow diagram illustrating one example of risk analysis in the present invention;

FIG. 3 is a chart outlining the Map Tools of the Map Tools Module of the present invention;

FIG. 4 is a screenshot illustrating the Map Tools of the present invention;

FIG. 5 is a screenshot illustrating the basic Selection tool of the present invention;

FIG. 6 is a screenshot illustrating the advanced Selection tool preview of the present invention;

FIG. 7 is a screenshot illustrating the advanced Selection tool applied to the basic Selection simulation;

FIG. 8 is a screenshot illustrating the Layer Catalog tool and its features of the present invention;

FIG. 9 is a screenshot illustrating the Exposure Chart delivered by the Exposure tool of the present invention;

FIG. 10 is a chart outlining the application settings in the Administration and User Setting Module of the present invention;

FIG. 11 is a screenshot illustrating what fields the user may configure in the Application Level Settings category of the present invention;

FIG. 12 is a chart outlining the features of the Layers Module of the present invention;

FIG. 13 is a screenshot illustrating the Layer Catalog of the present invention;

FIG. 14 is a flow diagram of the Layer Information Service of the present invention illustrating examples of how the Layer Information Service renders information about the various layers;

FIG. 15 is a flow diagram of the Map Service of the present invention illustrating one example of how the Map Service renders map images of the map layers to the user;

FIG. 16 is a chart outlining the features of the Models Module of the present invention;

FIG. 17 is a screenshot illustrating the different Models which may be simulated;

FIG. 18 is a screenshot illustrating a possible user drawn path for a Tropical Cyclone Model simulation;

FIG. 19 is a screenshot illustrating the completed Tropical Cyclone Model simulation;

FIG. 20 is a flow diagram illustrating one example of how a simulation is created;

FIG. 21 is a flow diagram of the Feature Service of the present invention illustrating examples of how Simulations may be created, updated and deleted, how a feature may be obtained, and how a previously saved simulation may be recalled;

FIG. 22 is a table illustrating the type of Model and the Pre-Model attributes that are considered for each Model;

FIG. 23 is a table illustrating the Pre-Model attribute descriptions;

FIG. 24 is a table illustrating the Model descriptions;

FIG. 25 is a table illustrating the type of Model and the Model attributes that are considered for each Model;

FIG. 26 is a table illustrating the Model Characteristic attribute descriptions;

FIG. 27 is a table illustrating the type of Model and the Post-Model attributes that are considered for each Model;

FIG. 28 is a table illustrating the Post-Model attribute descriptions;

FIG. 29 is a table illustrating the Vulnerability Matrix for a Seismic Model;

FIG. 30 is a flow diagram of the Query Service of the present invention illustrating one example of risk data is analyzed in the present invention;

FIG. 31 is a flow diagram of the Loss Calculation Service of the present invention illustrating an example of loss calculation in the present invention;

FIG. 32 is a chart outlining the features of the Data Analytics Module of the present invention;

FIG. 33 is a screenshot illustrating the Data Analytics features of the present invention;

FIG. 34 is a screenshot illustrating the Details feature of the present invention;

FIG. 35 is a screenshot illustrating the Data Header, Column Header and Row Header of the Details feature of the present invention;

FIG. 36 is a screenshot illustrating the rearranging of the Header categories in the present invention;

FIG. 37 is a screenshot illustrating the rearranging of the Header categories in the present invention;

FIG. 38 is a screenshot illustrating the addition of categories to the desired Header position from a Field List;

FIG. 39 is a screenshot illustrating the addition of categories to the desired Header position from a Field List;

FIG. 40 is a screenshot illustrating the addition of categories to the desired Header position from a Field List;

FIG. 41 is a screenshot illustrating the removal of a category from a Header position into the Field List;

FIG. 42 is a screenshot illustrating the selection of a cell in the Details feature for display of Details View;

FIG. 43 is a screenshot illustrating the Details View for the user selected Details feature cell;

FIG. 44 is a screenshot illustrating the selection of a group cell in the Details feature for display of Details View;

FIG. 45 is a screenshot illustrating the Details View for the user selected Details feature group cell;

FIG. 46 is a screenshot illustrating the sub-categories of each Header category;

FIG. 47 is a screenshot illustrating the sub-categories of each Header category;

FIG. 48 is a flow diagram of the Data Analytics Service of the present invention illustrating one example of data population of the Summary feature;

FIG. 49 is a flow diagram of the Data Analytics Service of the present invention illustrating one example of data population of the Details feature;

FIG. 50 is a flow diagram of the Data Analytics Service of the present invention illustrating one example of data population of the Details View;

FIG. 51 is a flow diagram of the Template Service of the present invention illustrating one example of how the Data Analytics templates are retrieved;

FIG. 52 is a chart outlining the features of the User Dashboard Module of the present invention;

FIG. 53 is a chart outlining the features of the Notifications Module of the present invention;

FIG. 54 is a chart outlining the features of the Reports Module of the present invention;

FIG. 55 is a chart outlining the features of the Data Input and Output Module of the present invention;

FIG. 56 is a flow diagram illustrating the inbound and outbound message format uses in the Data Input and Output Service; and

FIG. 57 is a flow diagram illustrating one example of how the Data Input and Output Service may import and export data in the present invention.

### DESCRIPTION OF THE REFERENCED NUMERALS

Turning now descriptively to the drawings, in which similar reference characters denote similar elements throughout the several views, the figures illustrate the User Interactive Insurance Risk Analysis Application of the present invention. With regard to the reference numerals used, the following numbering is used throughout the various drawing figures.
10 User Interactive Insurance Risk Analysis Application of the present invention
12 application modules
14 map tools module
16 administration and user settings module
18 data analytics module
20 layers module
22 model module
24 user dashboard module
26 notification module
28 reports module
30 data input and output module
32 map service
34 feature service
36 query service
38 loss calculation service
40 data analytics service
42 template service
44 filter tool
46 information tool
48 risk explorer tool
50 underwriter tool
52 map mark tool
54 reset tool
56 wipe tool
58 distance to feature tool
60 grid tool
62 selection simulation tool
64 feature selection tool
66 legend tool
68 layer catalog tool
70 reference map
72 model simulation tool
74 measurement tool
76 locate address tool
78 exposure tool
80 center tool
82 zoom tool
84 pan tool
86 satellite tool
88 print tool
90 basic selection tool
92 advanced selection tool
94 include selection tool
96 exclude selection tool
98 basic selection simulation
100 advanced selection simulation
102 site library
104 user library
106 shared library
108 layer catalog
110 WMS subscriptions
112 featured layers
114 recent searches
116 layer preview
118 exposure chart
120 application level settings
122 zoom settings
124 map mark manager
126 user manager
128 favorites manager
130 history manager
132 layer manager
134 feature settings
136 regional settings
138 subscription settings
140 filter manager
142 start-up settings
144 themes settings
146 languages settings
148 unit of map settings
150 authentication settings
152 membership provider
154 audit service
156 database settings
160 layer information service
162 thematic layers
164 layer weights
166 friend layers
168 sibling layers
170 group weights
172 detailed layers by zoom level
174 transparent layers
176 layer filter
178 layer groups
180 layers with advanced styling
182 field name configuration service
184 input variables
186 model data providers
188 notifications
190 dynamic hazard feed
192 customization of formulas
194 mathematical libraries
196 model service
198 monte carlo processing
200 grid computing
202 parallel computing
204 cloud computing
206 friend modules
208 loss calculation engine
210 loss calculation methodology
212 pre-model characteristics
214 model characteristics
216 post-model characteristics
218 damage methodology
220 vulnerability matrix
222 historical loss service
224 claims data
226 model list
228 user drawn tropical cyclone model track
230 model simulation
232 damageability bands
234 template manager
236 summary
238 details
240 details view
242 coverage
244 map snapshot
246 compare data between analysis
248 layer data analysis
250 selection analysis
252 model analysis
254 analysis filter
256 reinsurance treaty analysis
258 reporting data
260 exporting data
262 session data
264 private data
266 public data
268 settings data
270 session information
272 save session information
274 share session information
276 field list
278 select layer
280 select template
282 notes
284 data header
286 column header
288 row header
290 header category
292 cell selection
294 group selection
296 header sub-categories
298 business social networking
300 before and after major catastrophe
302 KPI alerts
304 events near searched locations
306 RSS feeds
308 customization of displayed web parts
310 internet protocol location technology
312 geo RSS feeds
314 application alerts
316 gadgets
318 events near map marks
320 affected areas
322 notifications filter
324 subscription groups
326 notifications service
328 electronic mail alerts
330 SMS alerts
332 rules of data input and output
334 subscriptions
336 data charts
338 exceedence probability
340 business intelligence
342 customization of data
346 underwriting on the fly
348 input validation
350 real-time updates
352 ACORD
354 WCF
356 data input and output service

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

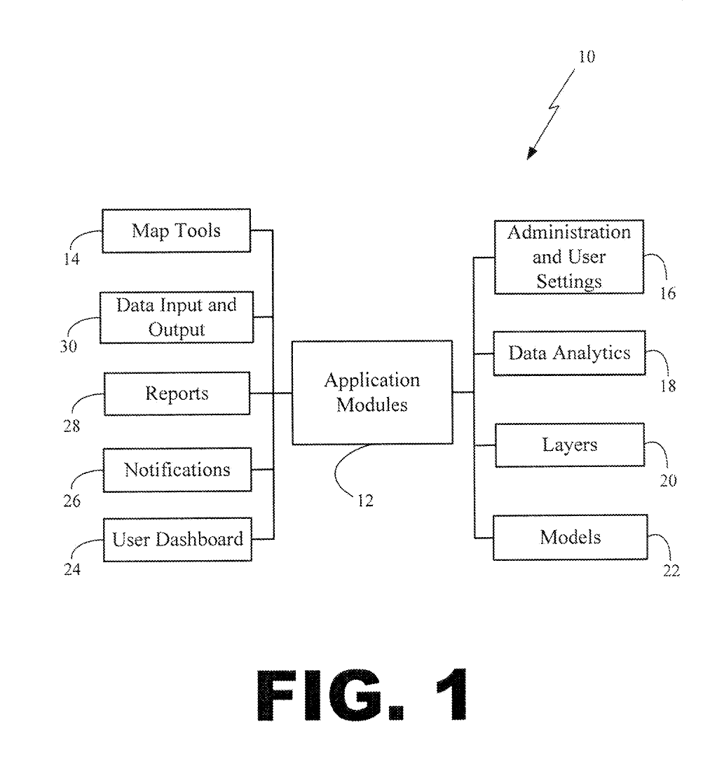

FIG. 1 is a chart outlining the application modules of the present invention. The present invention is created by forming various modules in a Graphical User Interface (GUI). These modules are Map tools 14, Administration and User Settings 16, Data Analytics18, Layers 20, Models 22, User Dashboard 24, Notifications 26, Reports 28, and Data Input and Output (I/O) 30. All modules utilize application specific Services from within each module. The main Services include Map Service, Feature Service, Query Service, Loss Calculation Service, Data Analytics Service and Template Service. The Map Service downloads map and GIS layers in the application. The Feature Service assists with Selection and Model Simulation storage and their displays on the layers. The Query Service is needed for data analysis. The Loss Calculation Service provides estimated loss values for the user created Selections and Models Simulation. The Data Analytics Service Template Service allows for user configuration of data display. Other services are also part of this application. For instance, the Layer Information Service allows access of information pertaining to all layers. The Model Service assists in the processing and creation of the various Model footprints with relation to the specific input variables the user has selected when constructing the model (provides the footprint of the Model-affected area). The Historical Loss Service assists the Loss Calculation Service by providing historical loss values which are taken into consideration when calculating loss for the portfolio based on the user constructed Model. The Data Input/Output (I/O) Service allows for importing and exporting of user data.

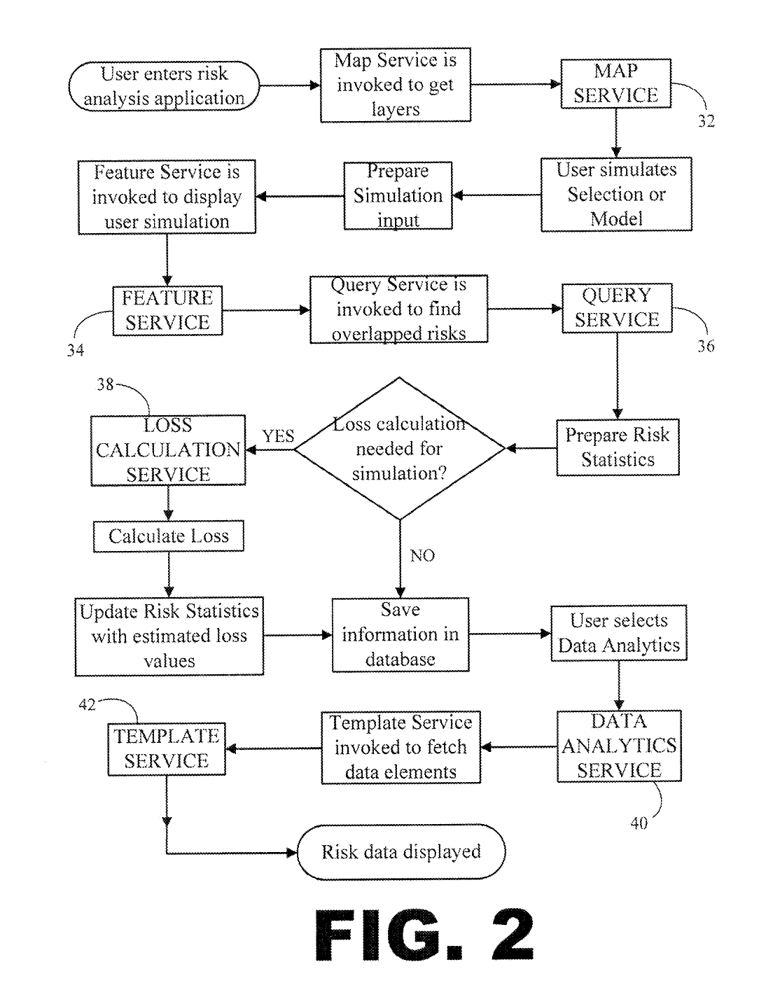

FIG. 2 is a flow diagram illustrating one example of risk analysis in the present invention. The user first enters the risk analysis application. Upon user entrance, the Map Service 32 is invoked to get all user configured initial load layers, including a map layer. Once the user simulates a Selection or Model, a simulation input is prepared. The Feature Service 34 is then invoked to store the simulation's geographic data then display the user simulation. The Query Service 36 is invoked to find overlapped risks between the features in a user simulation and portfolio data. Once the overlapped risks have been found, the Query Service 36 prepares risk statistics. In the case of a Model Simulation, the Loss Calculation Service 38 is invoked to calculate estimated loss. From the loss calculation, the risk statistics are updated with estimated loss values and the information is saved in the database. In the case of a Selection simulation, the risk statistics are saved in the database, without need for the Loss Calculation Service 38. Upon user selection of Data Analytics, the Data Analytics Service 40 is invoked, which in turn invokes the Template Service 42 to fetch the data elements for the Data Analytics display. This analysis may be performed against multiple layers for the same simulation. Finally, the risk data is displayed in a user configured format.

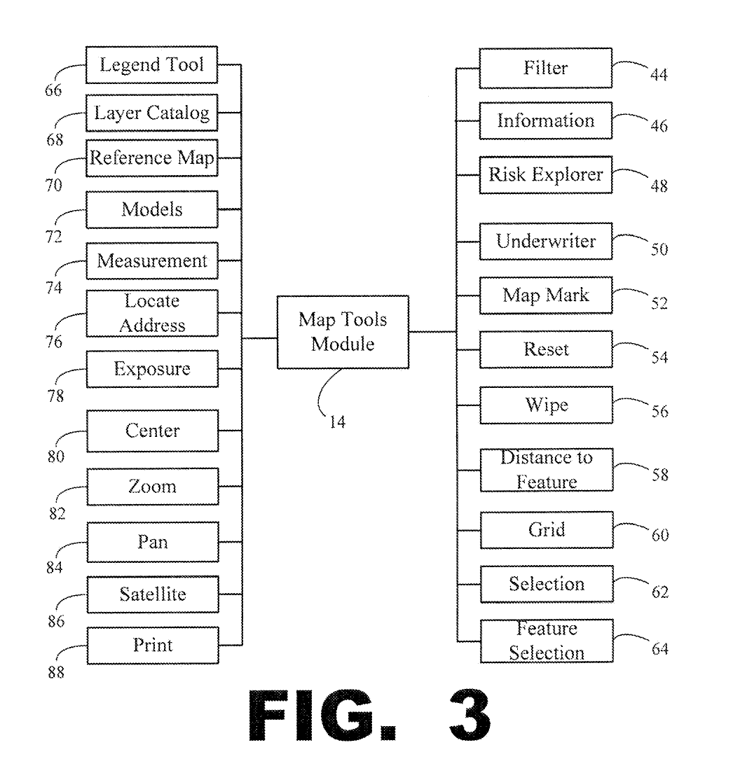

FIG. 3 is a chart outlining the Map Tools of the present invention.

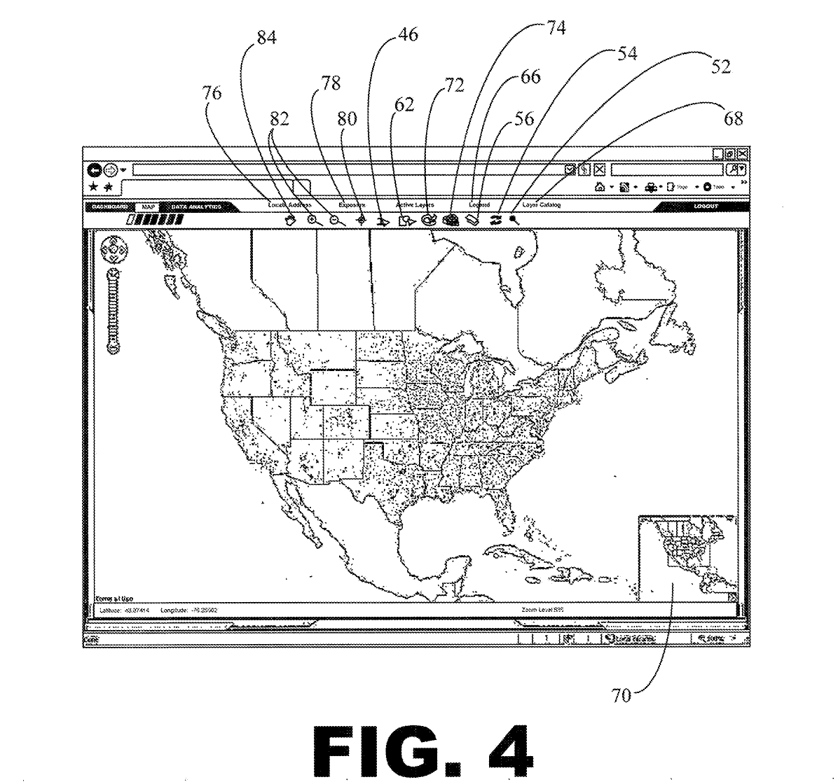

FIG. 4 is an application screenshot illustrating the Map Tools of present invention. The Map Tools help the user geographically visualize, manipulate and query data related to any map layer in the application.

The Filter tool 44 allows the user to create and apply queries to any map layer in the application based off the elements that have been configured as filterable. Furthermore, the filter may also instruct the Map Service to display the filtered elements geographically on the map. Different themes are available to distinguish between filtered and non-filtered results. Once the user creates a filter, the filter can be saved for later analysis.

The Information tool 46 provides the user with information about a chosen location. The information is contained, but is not limited to, the map layers that are loaded on the map. The Information tool 46 works in conjunction with the application to display only the data elements that are configured for display. The location the user selects for information is marked and may be selected by the user upon the closing of the Information tool 46 to retrieve the information instantly.

The Risk Explorer tool 48 is used to explore the configured data elements of a risk by geographically selecting a risk location on the map to return information. If a location is not directly selected, the application may perform spatial analysis to return the closest risk location from the desired location. Furthermore, the Risk Explorer tool 48 displays a satellite imagery of the risk location from various external sources.

The Underwriter tool 50 is used to manage risk location data. The user may add, edit, view and delete risk locations that have been added with the Underwriter tool 50 to the application. When a location is added to the application, data elements such as, but not limited to, the distance to terror target, nearest terror target location, distance to coast line, nearest coastline name, MMI value at the location, Federal Emergency Management Agency (FEMA) Floor Insurance Rate Map (FIRM) Zone, and Peak Ground Acceleration (PGA) values are calculated.

The Map Mark tool 52 allows the user to locate a desired location on the map. A list displays all map marks which a user has saved. A Map Mark Manager allows deleting of the saved map marks, as well as sorting based on various criteria, including but not limited to name, day created, region, user created groups or folder, and user's last visited location.

The Wipe tool 56 erases all user created layers, marks and selections made during the user's session while retaining the layers and current zoom level.

The Reset tool 54 resents the application to the state the application is found during initial load following user entrance into the application.

The Distance to Feature 58 tool allows the user to measure the distance from any geographical entity in a map layer to another geographical entity in either the same map layer or another.

The Grid tool 60 gives the user the capability to analyze data elements of any layer in a dynamically generated heat map. The Grid tool 60 gives user a high level analysis of exposure in arbitrary squares across the entire map. The Grid tool 60 provides analysis for numeric data by a user configurable meridian.

The Selection tool 62 allows the user to geographically filter and create a Selection simulation within an area on the map to receive portfolio data, underwriting statistics or any other user configurable information for all of the locations that are inside the user created Selection. Performance of geographical filtration may also be done by a user drawing. The Selection tool may be basic or advanced.

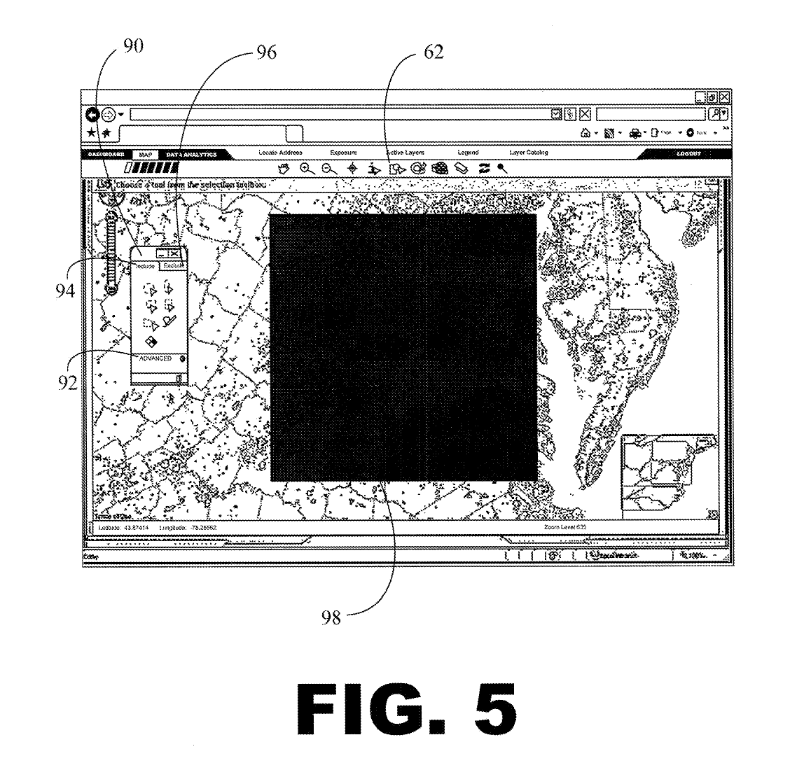

FIG. 5 is a screenshot illustrating the basic Selection tool of the present invention. The basic Selection tool 90 allows the user to geographically filter a single selection. Shown is the basic Selection tool 90 in use. The User first selects the desired shape or freehand drawing option. Shown here is the basic Selection tool placing a square shape on the map layer, allowing for inclusion 94 of all the risks within the square shape.

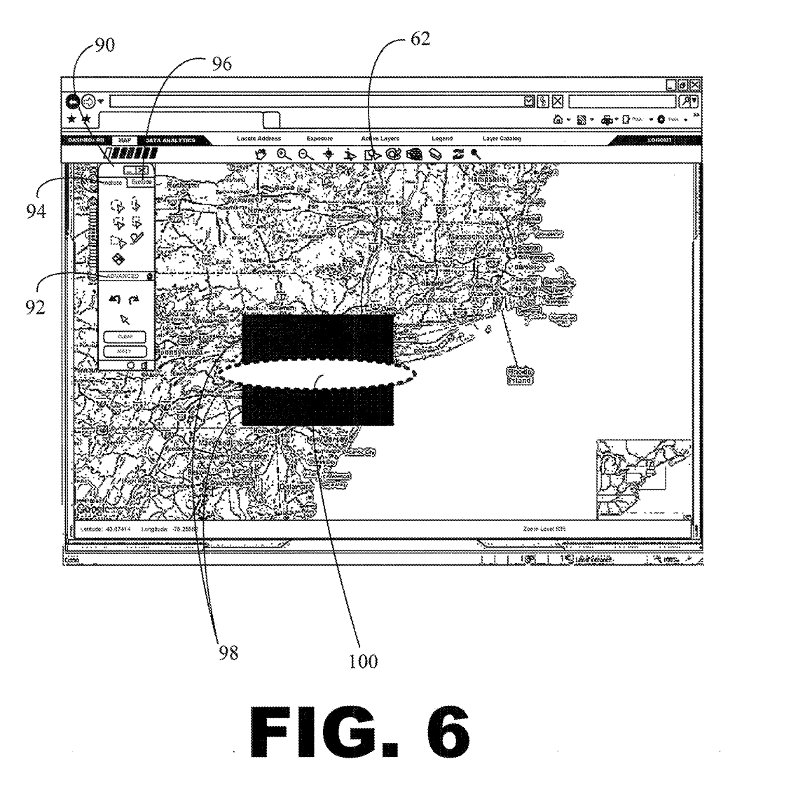

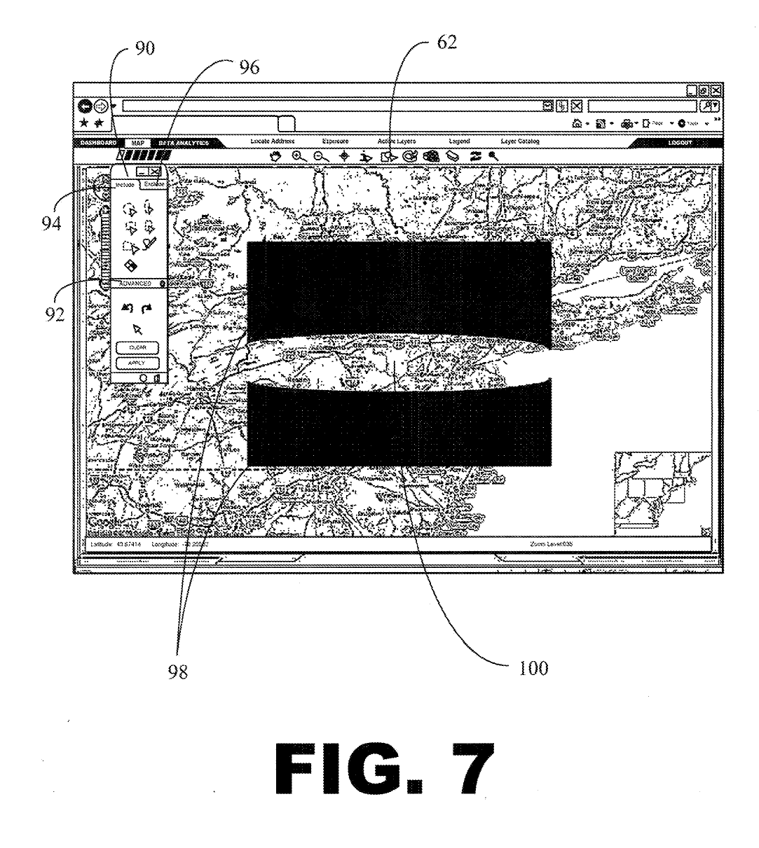

FIG. 6 is a screenshot illustrating the advanced Selection tool preview of the present invention. The advanced Selection tool 92 allows the user to geographically filter multiple inclusion 94 selections, and then within the inclusion, geographically filter multiple exclusion 96 selections. This may be done as many times within a selection simulation. Shown is the advanced Selection tool 92 in use. Once the user creates a basic selection simulation 98 using the basic Selection tool 90, the user may then select a second, or multiple, desired shape(s) or freehand drawing option to create an advanced selection simulation 100 within the basic Selection. Shown here is an exclusion 96 ellipse shape placed over the basic Selection 98. FIG. 7 is a screenshot illustrating the advanced Selection applied to the basic Simulation. Shown here is the advanced Selection simulation 100 ellipse shape excluding that portion from the initially placed basic Selection simulation 98 square shape. The user is now able to receive data from the Selection simulation, including desired portions and excluding desired portions. Each selection may be any shape or size the user desires. The user may undo or redo drawn selections at any time. The user may also clear all drawn selections and start drawing from scratch.

Going back to FIGS. 3 and 4, The Feature Selection tool 64 allows the user to grab features from corresponding layers and draw them as user selections. The user may also view brief descriptions about the desired drawn selection based on the configuration of the feature type a drawn selection belongs to, and may display basic statistics about an underlying layer's features. It also allows the user to move, resize, rotate, reshape and remove user drawn selections. Finally, the Feature Selection tool 64 allows the user to change the feature type of the user drawn selections (treating those shapes as Models), inputting the corresponding applicable parameters. The user may save the created selection simulations, and recall the selection simulations in future sessions.

The Active Layers tool allows the user to manage the various layers in a session. Active layers are the layers that are loaded into a user's session from the Layer Catalog. This tool displays layers on the map. The various layers that are in use may be re-ordered based on user's preference. Layer may be made invisible from the map. The tool allows the user to chose from and switch between a set of base maps, on top of which layers are added. These base maps may be from any desired external provider.

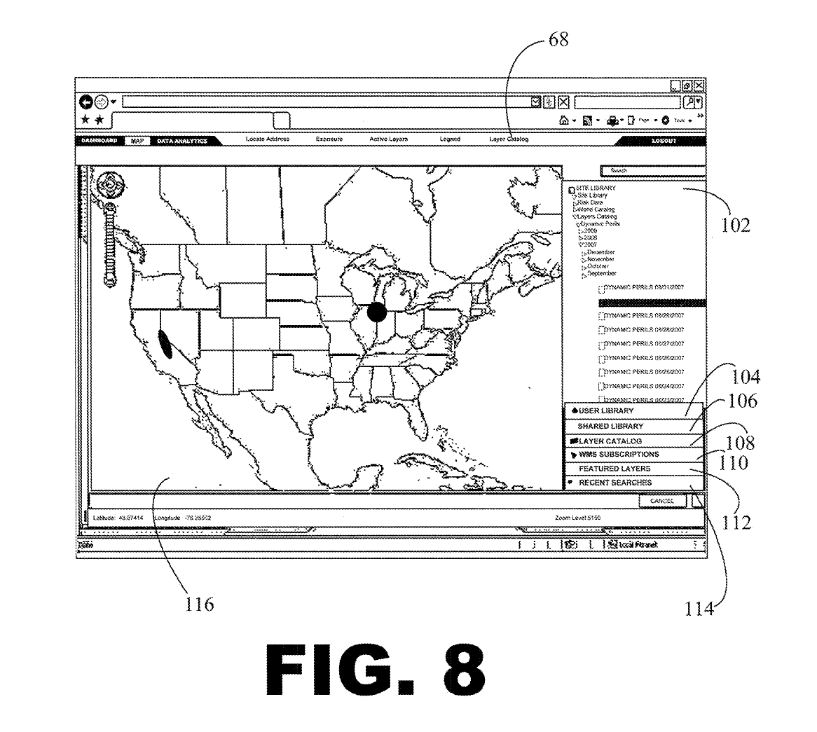

The Layer Catalog tool 68 allows the loading of additional layers to the user's session. FIG. 8 is a screenshot illustrating the Layer Catalog tool of the present invention. Shown is an example of additional layer lists and categories that may be available. Also shown is one aspect of the functionality of the Layer Catalog tool 68; the ability to preview any layer in the application. The User may preview these layers before loading to the application through the use of an interactive preview map. For example, within the Layer Catalog the user may select the group “Dynamic Peril”, then select a historical event from that group, which will zoom into the map an area that the historical event affected. In this example, the user is given a layer preview 116 of the historical event. The user may also read about the layer and learn about its recommended usage in the application.

The Layer Store, Site Library 102, User Library 104, Shared Library 106, Web Map Service (WMS) Subscriptions 110, Featured Layers 112, Recent Searches 114 and Saved Searches are lists of layers and search terms contained in the Layer Catalog tool 68. The Layer Store displays all map layer catalogs and all their map layers that are available for purchase. The Layer Store also provides the capability for the user to purchase these layers directly. The Site Library 102 displays all the layers that are available for immediate load on the map. The layers are arranged in categories that contain similar types of maps. The User Library 104 displays all the layers which are available. The Shared Library 106 is a collection of layers that may be shared with other users in the user's organization. The WMS Subscriptions 110 Library is a display of all the user subscribed external WMS Service layers which are available. The Feature Layers 112 is the featured, or favorites, display of layers that are created by the user. The Saved Searches list is a display of saved searches. The Recent Searches 114 list is a list of search terms recently searched. In addition to the lists, there is a search function that may search within the tool allowing the user to quickly search for any layer from the above mentioned layer lists. The search query may be saved by the user to the Saved Searches list.

Back to FIGS. 3 and 4, The Reference Map tool 70 provides the user the ability to quickly change the map viewing area while retaining the same zoom level. The Reference Map 70 indicates user's current location on the main map window corresponding to the edges of the current map until the zoom level drops below user specified miles. It then displays a crosshairs showing the center of the map. The user is able to drag and drop the square in the reference map which pans the map accordingly.

The Model Simulation tool 72 allows the user to create a deterministic event to measure exposure to an event and estimate the loss potential from that event. The simulations are accomplished using historical data from external data sources, random selections and user input variables. User may specify the model, location, magnitude and duration of the event as well as the vulnerabilities of the affected properties. User may select the model to be simulated. User may set the location and draw the path of the model. When simulating tornado or hail, the user is restricted to drawing only a northeast direction and for outbreak only in a southeast direction since this is the path direction a real tornado or hail storm would take. User may set the intensity along with other attributes that vary with the type of model. The user created simulations may be saved and the user may simulate saved models on new locations or originally saved locations. When applicable, Monte Carlo processing, Grid computing, Parallel computing, Cloud Computing, or a combination approach is used to calculate loss for immediate and accurate results.

The Measurement tool 74 measures the distance between two or more points. User may view the path being selected along with the tool tip help, which is in user configured unit of map setting based on the user's measurement of preference. After completing the measurement, the user may view the overall distance drawn or the distance to each point on the path from the starting location through a tool tip which appears by hovering over the drawn line or the points on that line.

The Locate Address tool 76 searches the map for the desired address or feature locations in the current session. The user is able to search for any feature or address on the map. The Locate Address tool 76 then returns the matching results in order of best match to worst match. The user may request the tool to return to a single, closest, search location as well. After the user selects a location from the search results, the map view is centered at the returned latitude and longitude coordinates along with the proper zoom level based on the geocoded (latitude and longitude) accuracy level. This selected location is added to a list of previously selected locations (visited locations history), which is maintained throughout the session. The user may remove locations from this list or clear the list all together. Upon selection, the tool also adds an indication to the map view at the corresponding location. The user may select the indicator at any time and view the latitude, longitude and location name. The users may hide the indicators from the map view through the visited locations history list. The user may go back to the list at any time, chose a location and the map view is redirected accordingly.

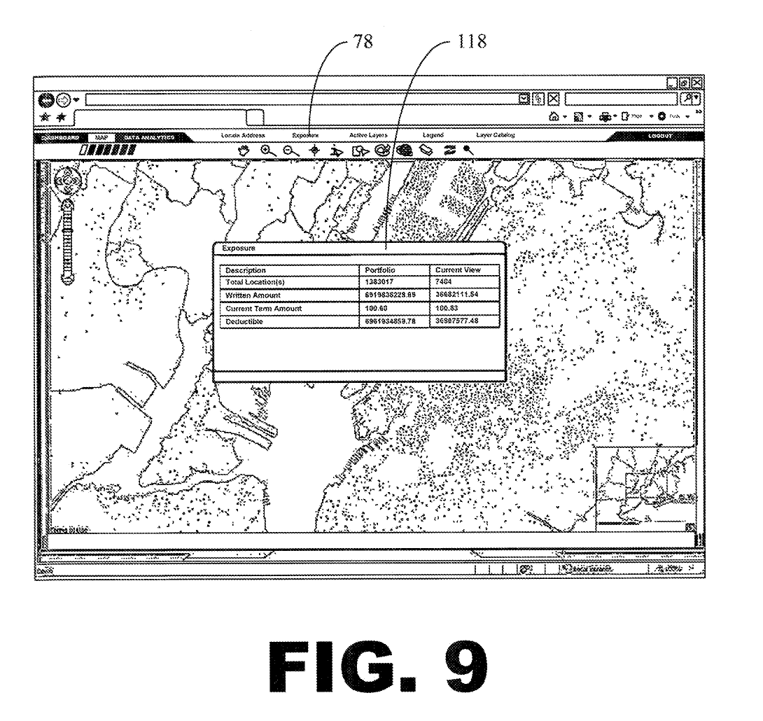

The Exposure tool 78 allows the user to view specific data in the region of the current map view. FIG. 9 is a screenshot illustrating the Exposure chart delivered by the Exposure tool of the present invention. As the user moves between different areas and different zoom levels on the map, the portfolio data in the Exposure chart 118 changes accordingly. Included data fields in the display may be the total number of risk locations, the written amount of the policies, the current term amount and the deductible. Again, the user may configure which data fields will be present. When the map page loads, the saved configurations are displayed.

The different modules of the application appears on the user interface. The Map displays the map photo, the map legends and the list of layers that are currently on the map. Data Analytics displays tool specific data. For example, if a model is applied or a selection is created, data concerning the model will be displayed and a Data Analytics Summary table will also be displayed. The user is able to specify what is seen with the map (legends or layers) and what data the user would like to see in Data Analytics. The User Dashboard displays a Key Performance Indicator (KPI) short summary of reports, notifications, user management and task assignments.

FIG. 10 is a chart outlining the configurable application settings in the Administration and User Settings of the present invention. The Administration Module 16 allows an administrator to configure various aspects of the application for customizable use by an administrator or an end user, depending on the feature or tool.

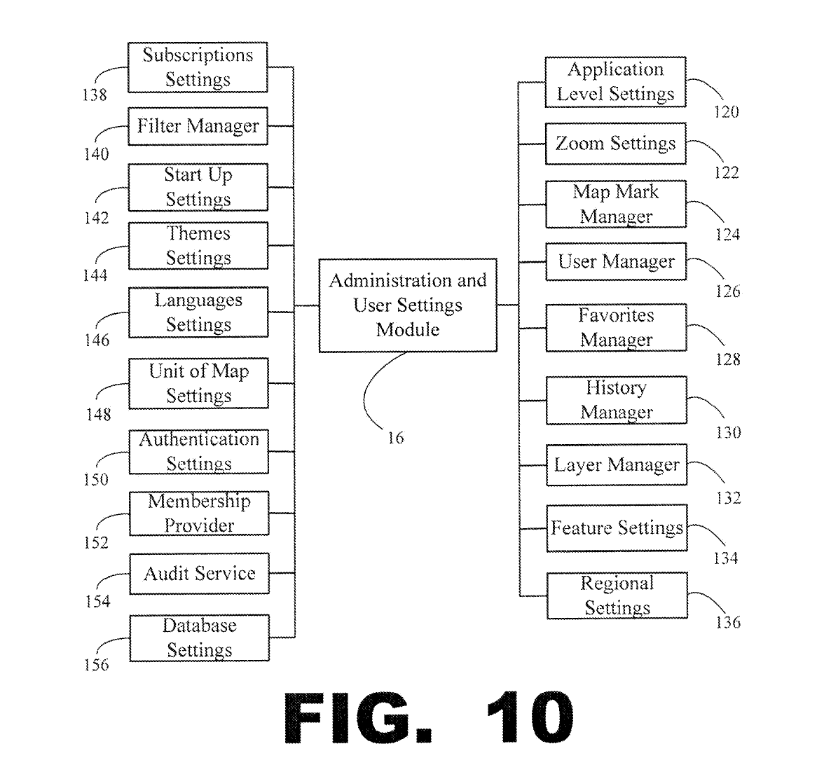

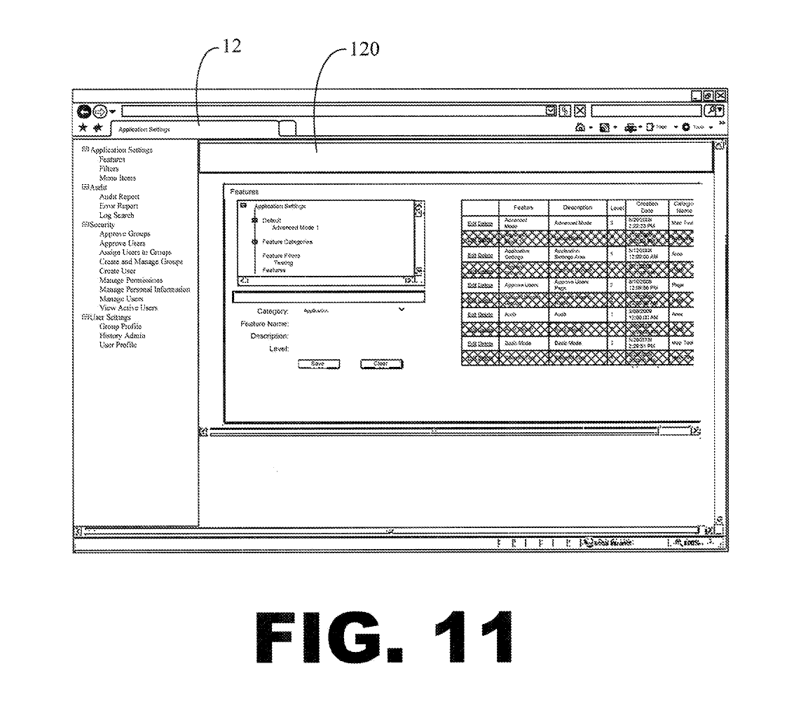

The Application Level Settings 120 are configurable by the administrator. Connection management, or database settings, may be changed as well as endpoint management and exception management. FIG. 11 is a screenshot illustrating what the user sees and what the fields the user may configure in the Application Level Settings of the present invention. Also shown are the various settings which may be configured. Whichever setting the user selects, data fields specific to that setting will be displayed for user configuration.

The administrator may change the settings of the zoom level using Zoom Settings 122. The number of zoom levels may be selected as well as different scale measures. Settings within each zoom level may also be modified.

The user control saved map marks in the Map Mark Manager 124. The Map Marks can be saved or deleted from a map mark list. Furthermore, the administrator has the option to undelete certain map marks within a ranged date which is configurable by the administrator. The administrator may also view sets of map marks, rename map marks, view map mark descriptions and view whether the map mark is active or inactive.

User settings may be controlled in the User Manager 126. The number of logins by each user may be viewed along with the date and time. The administrator may view all available users, register new users, update user information, delete existing users, enable or disable users, view users currently logged in, view all actions users performed, view user filter history, view all errors users experienced, and assign different roles to users.

User favorite locations, news feeds or other data fields within the User Dashboard may be configured and managed in the Favorites Manager 128. The administrator may view favorites, can rename these saved favorites and view the content of the favorites description.

Administrators may monitor the usage of the users individually in the History Manager 130. This is similar to an event log for individual users.

The administrator has administration control over layers in the Layer Manager 132. System wide internal and external layers may be added to the application by the administrator, which can be removed as well. Here, the administrator may also set a default Layer for data analysis.

Common application features may be configured with Feature Settings 134. The administrator may adjust features, themes, feature filters, filter values, menu items, units of measurement, and feature categories.

Creation, deletion and modifications of settings according to a specific region may be performed with Regional Settings 136. The administrator has the rights to change the date formats, currency symbols and number formats. The application is multilingual and the administrator has the ability to change the language used in the application.

The Subscriptions Settings 138 gives preferences to the news or articles which may be modified, deleted or created in the subscriptions. This feature may be available through Keyhole Markup Language (KML), Geographic Really Simple Syndication (GeoRSS), Common Alerting Protocol (CAP), Geography Markup Language (GML), and Really Simple Syndication (RSS). The types of subscriptions that are available to the users are configurable by the administrator.

The administrator has the ability to monitor the filters that are created by the users in the Filter Manager 140. The administrator may add or delete the filters for the application as well as rename the saved favorites, view filter descriptions and monitor the status of the filters.

The administrator may configure the load settings of the application with Start Up Settings 142. This is where the administrator has the option to go to a specific map mark or location on the map upon user entry into the application.

The administrator may enable or disable a layer theme with Themes Settings 144 which is configurable by the user.

With the Languages Settings 146, the administrator has the option to choose the types of languages the user views the application in. An Application User Interface (API) allows the application to support several languages. The application determines the user's current location and suggests the first time load language. User also has the ability to choose the most suitable language.

The administrator may configure the different types of units that are available for the different features with Unit of Map Settings 148. The user may choose from different map units like miles, kilometers or meters.

The administrator may authenticate the users according to specific settings the administrator chooses with Authentication Settings 150. The administrator may define password strength policy, enable or disable Captcha functionality for password recovery, set login options (such as timeout for user login or the number of maximum users logged in at any time via an API), set Internet Protocol (IP) based security, enable or disable biometrics for authentication, and include policy terms of use for registration. Within the authentication feature is a biometrics service. This biometrics service accepts a user ID and a binary object of the user's fingerprint image and verifies that the fingerprint provided by the user matches what is in the database for that user. At least three fingerprints per user are saved into the database. An API analyzes the fingerprint images and assures that they match. A third party is used to verify the fingerprint and a code library performs the verification.

The Membership Provider 152 allows different types of roles or permissions that the user is given for the application by the administrator. The administrator may select the provider type from an Active Directory (AD), Lightweight Directory Access Protocol (LDAP) or Custom Authentication Structured Query Language (SQL) server. The administrator sets the configuration information for the selected type. The administrator may then define user roles. For example, the administrator may see all roles that are available, save role information, set features that are available and unavailable for the role, and delete the role from the system.

Users of the application will have custom settings which they will want saved, such as history, favorites, style, culture and other features. A UI manages the user's history. A WCF service is implemented to save this kind of information about the user for retrieval when necessary. The user settings service retrieves information about the preferences based on the user ID. It also retrieves preferences for a group of users. The users may modify their own settings and administrators may view or modify all settings.

All users perform multiple actions in the application which are logged for auditing purposes for administrator use via an Audit Service 154. A WCF service is used to log all user actions, possible errors and manage the given information. The Audit Service's 154 main functionality is to write user actions in the UI and errors that happened anywhere in the application. The administrator is able to view reports against the user action log and application error log based on user name, dates, actions or errors occurred, IP address, and values in the database table.

FIG. 12 is a chart outlining the application features of the Layers Module of the present invention. The Layers Module 20 represents various features that are used to manage a map layer in the application. A layer is common to the application services. A layer is created in the form of a map from the Map Service 32 for informational purposes within the Layer Information Service. The Layer Information Service 160 provides the user with any information that is requested for any layer in the application as well as any associated layers. The Layer Information Service 160 may also return data for user configured elements in the application for each layer at a location, return all layer categories for the Layer Catalog tool, returns all layer information in the Layer Catalog tool, returns Analysis Layer information for the user configured elements in the application for the analysis location closest to the location submitted, and returns all preconfigured base layers and their information.

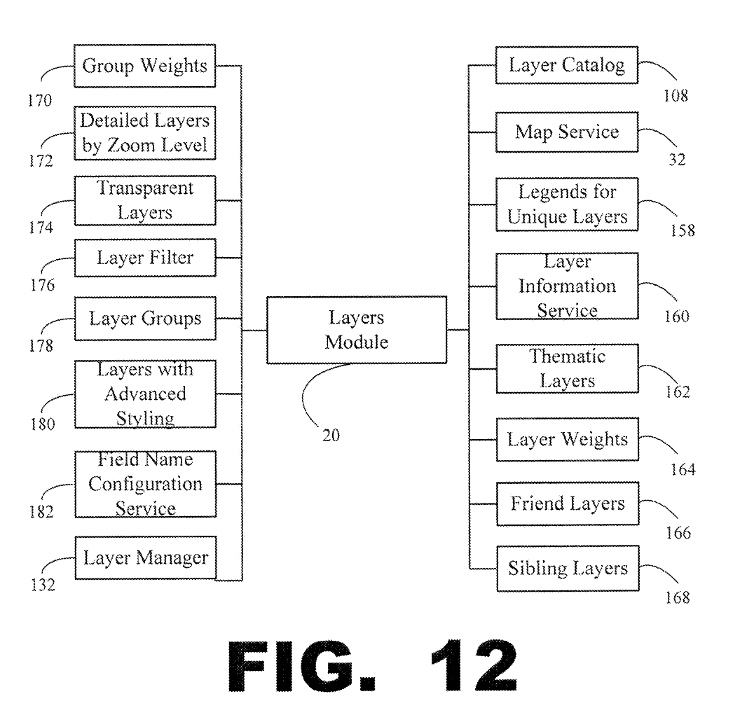

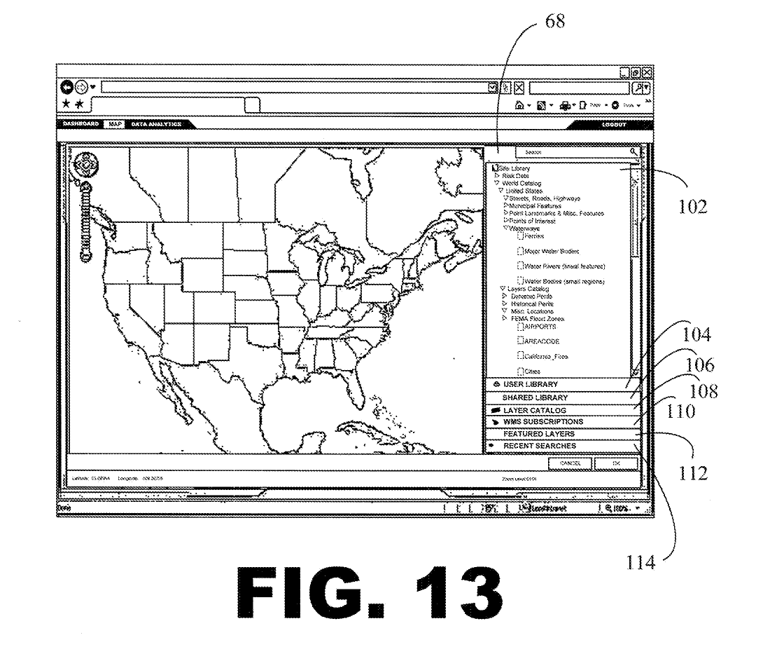

The Layers Catalog 108 contains all of the layers, including map layers and analyzable layers that may be loaded during a session. FIG. 13 is a screenshot illustrating the Layer Catalog of the present invention. Show are the categories which may be included in the Layer Catalog tool 68. In FIG. 12, The Layer Information Service 160 reads all the layers from the available catalogs which they are associated with. Layers depicting any and all types of information are present or downloadable into the Layer Catalog 108 for use. The Service is able to act as a client to the map service and request a map object using the map control to display the base layers and a single layer. The Layer Information Service 160 is capable of searching all available layer catalogs, including layer catalogs shared with other users or organizations, for any layers which match a name, description or keywords.

The initial layer which is loaded is a base map layer (FIG. 4). This map layer is loaded through tiling by the Map Service 32. Each tile is populated with risk locations. These risk locations may be depicted upon initial load via a heat wave map or other marking if the user selects as such. The more condensed the region, the more risks in existence. The more sporadic the region, the fewer risks exist. The map image may be rendered to the user through WMS, Active Server Method File (ASMX) service, or Hypertext Transfer Protocol (HTTP) handlers. Other services may be implemented in place of those described herein.

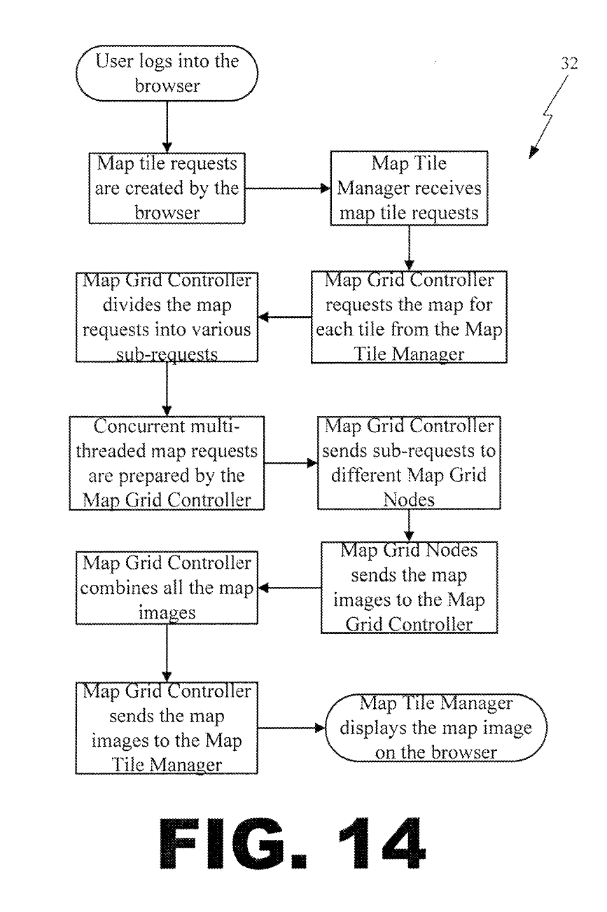

FIG. 14 is a flow diagram of the Map Service of the present invention illustrating one example of how the Map Service 32 renders map images of map layers to the user. The user first enters the risk analysis application. Map tile requests are created by the browser and sent to a Map Tile Manager. A Map Grid Controller requests the map for each tile from the Map Tile Manager. The Map Grid Controller divides the map request into various sub-requests and the concurrent multithreaded map requests are prepared. The Map Grid Controller sends the sub-requests to different Map Grid Nodes. The Map Grid Controller then receives the map images from various Map Grid Nodes. The Map Grid Controller combines all the map images and sends map image to the Map Tile Manager, which then displays the map image on the browser.

The Map Service 32 also loads additional layers onto the map. Once the Layer Catalog has been opened, the user selects the desired layers to be loaded. The Layer Catalog requests from the Map Service 32 that the layers selected be loaded. The Map Service 32 then loads the layers on the map for display and triggers other tools to display the appropriate information.

The present invention has the ability to load different base maps layer such as GOOGLE, YAHOO, MAPINFO, BING, etc. These maps are also implemented by tiling. Tiling provides for image caching and increases the user's experience. An open layers framework renders the map images as small tiles.

Depending on the task the user wishes to perform, the user may need to load various layers. The user may obtain layers via external services or may bring in their own layers for use with the application. The user may also share the Layer Catalog with other users. The Layer Catalog supports loading of the layers of the map which is further supported by Web Feature Services (WFS) or other standards such as WMS, GML or KML; certain layers have a provision to load onto the map thorough a SQL database. These layers provide total exposures in the Data Analytics module. Within the layers module are Thematic layers which can be styled thematically. The layers in the application which are thematic display risk data. The thematic layer creation feature allows the user to create a thematic layer from existing layers easily.

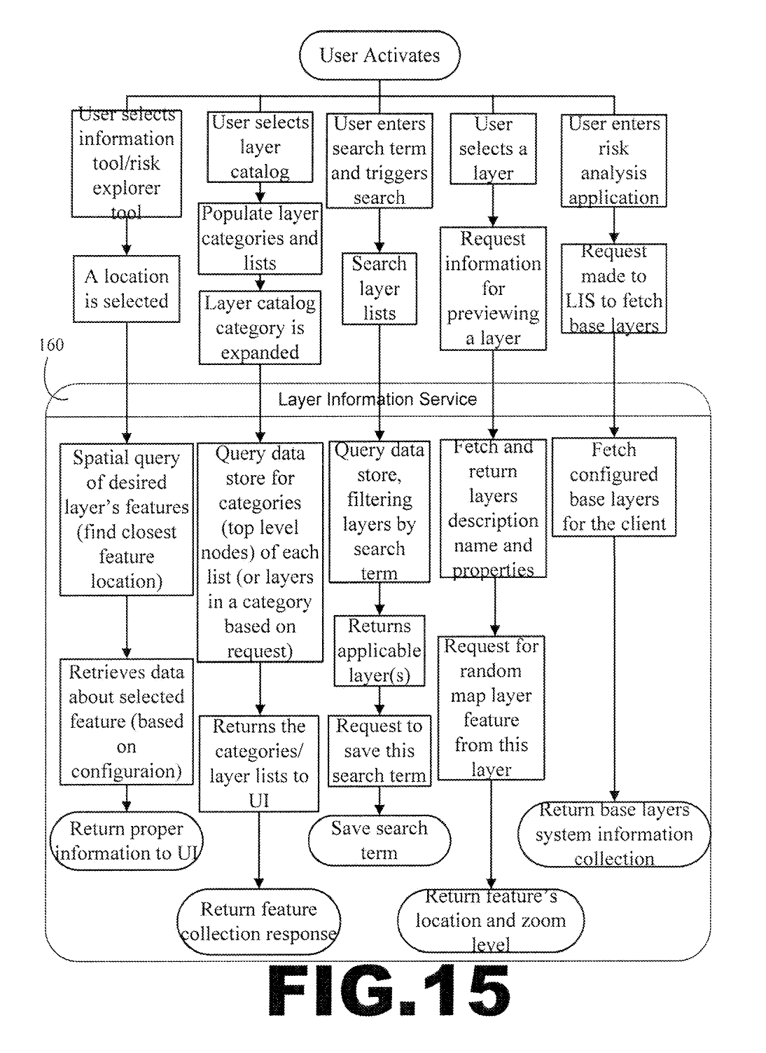

FIG. 15 is a flow diagram of the Layer Information Service of the present invention illustrating examples of how the Layer Information Service 160 renders information of layers and rendering non-map layers to the user.

To obtain information on the layers, the use may do so using the Information tool, Risk Explorer tool, and Layer Catalog tool. When using the Information tool, the user first selects the tool and chooses a location for information about the map layers. The Information tool requests information about each loaded map layer from the Layer Information Service 160. The Layer Information Service 160 performs a spatial query against the layer to return the data for the elements that have been configured for display in the tool. The Layer Information Service 160 then returns information for each map layer about the location to the application for display.

When using the Risk Explorer tool, the user first selects the tool. The User then selects on or near the desired risk location. The Risk Explorer tool requests information about the risk location layer from the Layer Information Service 160. The Layer Information Service 160 performs a spatial query against the layer to find the closes policy location from the user's selected location on the map. The Layer Information Service 160 retrieves the data for the elements that have been configured for view by the tool about the risk location. The Layer Information Service 160 then returns the risk information for display.

When using the Layer Catalog tool, the Layer Information Service 160 accomplishes the tasks of populating layer lists, populating search lists, drilldown into layer categories, searching all layer lists, a previewing a layer. When the user selects the Layer Catalog tool, the layer lists are populated. The tool requests from the Layer Information Service 160 the top level of categories for each list in the catalog. The Layer Information Service 160 then queries the data store and returns the top level of categories for each list to the UI for display. For populating search lists, the user selects the Layer Catalog tool, which requests the recent and saved search lists of layers from the Layer Information Service. The Layer Information Service 160 queries the data store for the recent and saved search lists of layers and returns results to the UI for display. For user drill down into the layer categories, the user selects a category in the layer list. The Layer Catalog tool then requests from the Layer Information Service 160 the layers in the category and other sub-categories. The Layer Information Service 160 queries the data store for the layers in that category, then returns the layers to the UI for display. For user search of all layer lists, the user enters a search term and triggers a search. The Layer Catalog tool makes a request to the Layer Information Service 160 to search based on the term through each list. The Layer Information Service 160 then queries the data store for the layers for each list to the UI for display. The UI updates each list with the result count. The search control requests the Layer Information Service 160 to save the search term and what was just used. The recent search control is then updated by the Layer Catalog 108 to reflect the last search in the list. For layer preview, the user first selects a layer from the Layer Catalog. Information is requested from the Layer Information Service 160 for the layer properties. The information for the layers' description name and other properties are displayed. The Layer Catalog requests from the Map Service for the layer to be loaded in the preview pane. The Layer Information Service 160 is requested to get a random geometry entry (map layer feature) from a map layer and returns the location and zoom level of the random feature. The map preview is centered over the location at the appropriate zoom.

The Layer Information Service 160 also performs the operations of loading layers on the map and getting base layers. Once the Layer Catalog is selected, the application requests from the Layer Information Service 160 the base layers used to build the base map layer. The Layer Information Service 160 then returns the layers used to construct the base layer map. The application caches this information to be used upon request by the various tools.

Back to FIG. 12, the different layers of the map are placed according to the Layer Weights 164, or weights assigned to each layer. A weight is a property of a layer that identifies where the layer should fall when loaded with other map layers on the map. This allows the map layers to display appropriately on the map. Layers are also loaded without request. These layers, Friend Layers 166, are layers that are associated with another layer and contains instructions that require the loading of the associated layer when the layer is loaded. These layers may share similar resources such as themes and roles. For example, when the user selects the “major highways” layer for viewing, the major highways are seen on the map as well as the highway shield identifying the roadway. The highway shield layer is the Friend Layer of the major highways layer. Another process that modifies this approach is a Sibling Layer 168.

A Sibling layer 168 is a map layer which serves the same purpose as another layer. They both present the same type geographical element on a map, but one does so with a higher level of detail than the other depending on the zoom based on the display setting of the layers. The Sibling Layers 168 are toggled on or off when the zoom level changes. For example, a layer named “state borders low detail” is loaded in high altitude at the zoom level where less detail is appropriate, and the sibling level “state borders high detail” may be toggled in its place when the zoom level is at a lower altitude and more detail is needed.

The Detailed Layers by Zoom Level 172 shows different layers and its details when the map is zoomed into different levels. Layers are shown at their specific zoom levels. This detailed layers by zoom level is used in order to hide details when the zoom is set farthest from the surface of the earth and show more detail when the zoom is closest to the surface of the earth.

The Layer Catalog 108 contains a Layer Filter 176. The layers may be filtered and loaded accordingly. This feature gives the user the ability to save the filtered layers and new layers. The user may also manage the layers in a session using the Manage Loaded Layers feature. Furthermore, certain layers may be grouped into Layer Groups 178 by symbols, styles or other user selected categories.

The Layers with Advanced Styling 180 feature allows for the adding of advanced styling to the layers being viewed. The user may specify the label text, reset the default label text and specify the label layout.

The Legends for Unique Layers 158 feature allows the user to display a legend for the layers that are active during the session. Legends are accessed through the Legends Service. A legend can be configured to describe feature data on a layer, for example, a legend reflecting population ranges for countries layer. Legends configuration may be dynamic, based on layers meta-data. A layer may have more than one legend configured for its use. A legend may be used by many layers with similar meta-data. The legend control dynamically reflects each layer's feature display, based on zoon level the layer is visible at as well as the corresponding friends and siblings of that layer.

The Layers module contains a Field Name Configuration Service 182 and UI. This service assists the user in configuring the fields and the names of those fields by each map layer. The UI helps the user visually modify and show or hide the field names for the application. Each map layer has multiple field names. Each field name may be formatted for different features in the application. The user may configure field names by layer or by function. Using the Field Name Configuration by Layer, the user is able to configure a layer's field name, display name and format. Using the Field Name Configuration by Feature, the user is able to configure features with the layer display names. A validation check is done to verify that at least one display name is selected for each feature.

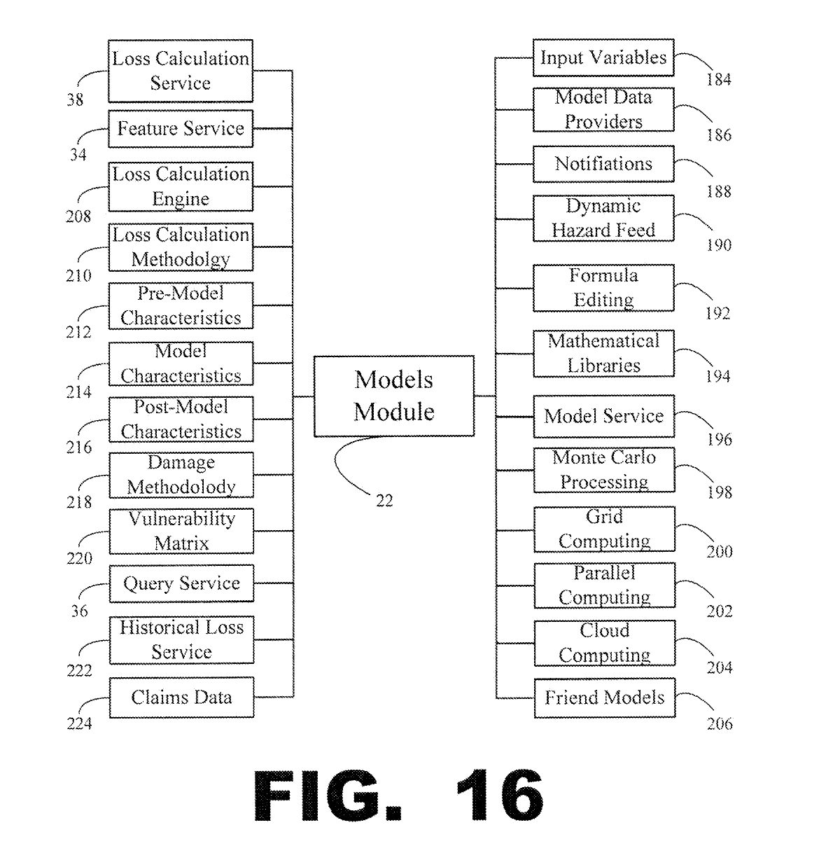

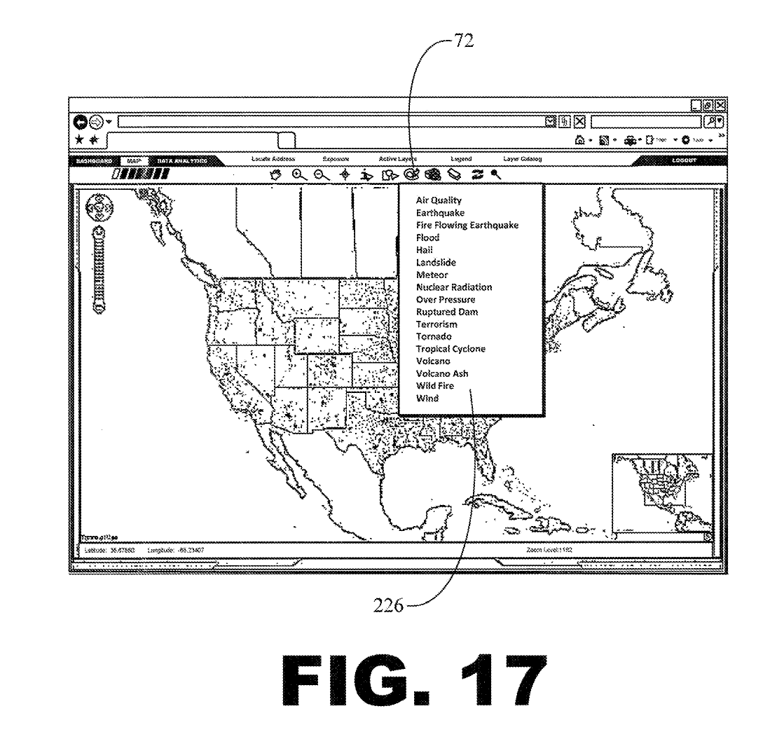

FIG. 16 is a chart illustrating the features of the Models Module of the present invention. The Models module 22 allows the user to perform model simulations. The model simulations may be based on historical data and random data which may be selected and narrowed down based on the input variables the user selects. The user has a multitude of options for performing a model simulation. FIG. 17 is a screenshot illustrating the different Models which may be simulated. Shown is a Model List 226 of the included Model types. Once the user selects which type of peril to simulate, the user can select the simulation to be performed based on historical data, random data or a combination. The user may draw the path the model will follow directly onto the map. FIG. 18 is a screenshot illustrating a possible user drawn path for a Model simulation. Shown is a user drawn Tropical Cyclone Model Track 228. The user may draw the path with as many miles, radius size or turns as desired; the path may follow any size or shape. The user may then perform the simulation by manipulating input variables from a range provided by the application for the different variables. The ranges that are available for each variable depends on each variable selected previous. For example, if the user draws a path for a tropical cyclone model, the user is given at least three input variables: category, intensity of wind and forward wind. The user first selects the category, which ranges from tropical depression (TD), tropical storm (TS), and hurricane 1-5 (H1, H2, H3, H4 and H5). Whichever value user selects gives a different range for intensity of wind depending on the selection for the input variable for each category. User once again selects from the given range (intensity of wind) which leads to a range for forward speed. These ranges are based on the standard hurricane scales. Every possible model follows the same concept. Each model has input variables specific to that model. All input variables are based on category specific ranges.

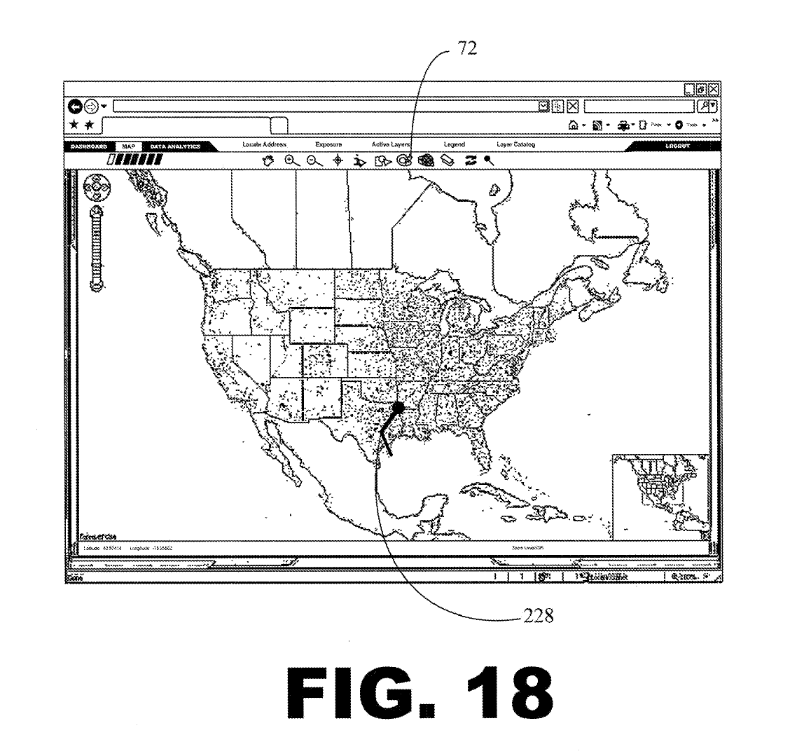

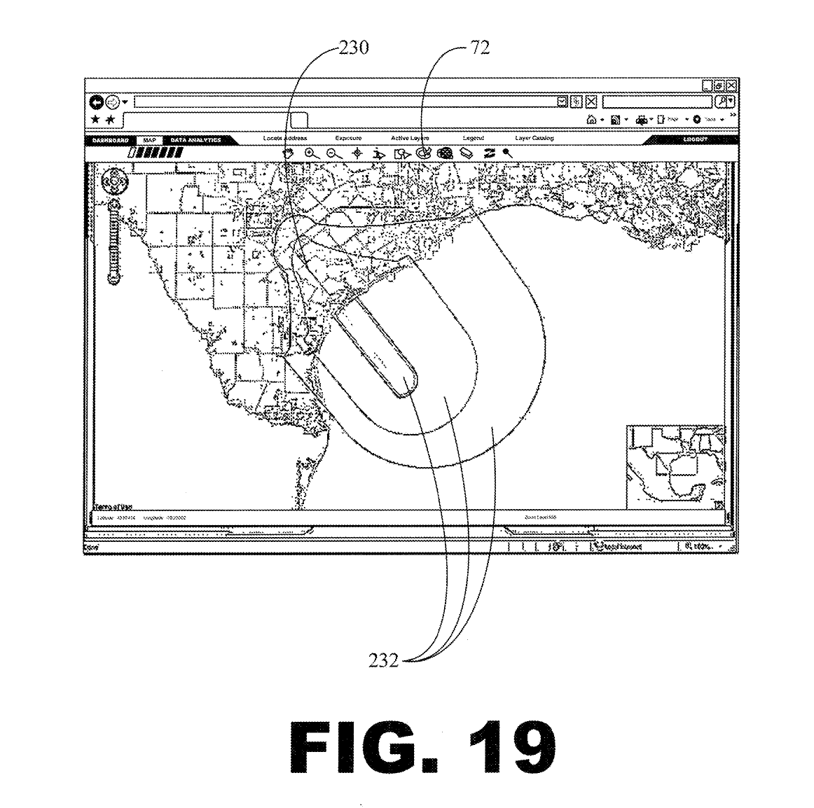

Once the input variables have been selected, the tropical cyclone, or model selected, will be shown on the map with all the affected areas as well as extent of damage and loss. FIG. 19 is a screenshot illustrating the completed Tropical Cyclone Model simulation 230. Shown is affected areas of the Tropical Cyclone in damageability bands 232. Every type of Model simulation will have results unique to that type of model. Using Data Analytics, the user may look into various data of interest. The Reinsurance Treaty feature within Data Analytics allows users to view the statistics of their reinsurance treaties as applied to a model simulation, such as treaty layers, total due on layers or total due on layers for participants. The user may analyze the data and configure data presentation through the layers of the reinsurance treaty to the amount of money user may collect from reinsurance participants/cedants.

Returning to FIG. 16, Model data providers 186 are used to provide real-time, historical peril events from around the globe. These are external sources implemented in the application through the web. Any web service may be used including: Storm Prediction Center (SPC), Weather Services Inc. (WSI), United States Geological Survey (USGS), National Oceanic and Atmospheric Administration (NOAA), U.S. Fire Service, Federal Emergency Management Agency (FEMA), U.S. Department of Homeland Security (DHS), and the Department of Energy. GIS data layers containing actual historical peril events including the required parameters are included in the application which assists in the model simulations user performs.

Users who subscribe to the notifications service receive Notifications 188 about dynamic hazards and severe weather information on a daily basis. The administrator may customize the Dynamic Hazards Feed 190 within the Notifications 188 based on certain attributes such as affected policies, location, intensity, type and so forth. The administrator may be selective about the internet sites from which to receive feeds for each event. A link to the site is included in the notification. The user has two options for downloading dynamic hazards. The first option is to manually download. The user may view feeds about a dynamic hazard then manually add the dynamic hazard into the layers catalog. The user may then rename those added dynamic hazards. The second option is to automatically download. The user may allow automatic insertion of the dynamic hazards events to the Layer Catalog on a daily basis. The user may also configure the type of dynamic hazard event to load based on the conditions to load it.

The simulations of the models are done with the help of predefined mathematical Formulas. Each model that may be modeled corresponds to a formula. The process uses the historical, random and user defined parameters to generate a model event footprint based on scientific principles and formulas. Mathematical Libraries 194 are used in the application to solve the equations in the formulas. The Query Service 36 uses a geometry layer generated by a Model Service 196 to analyze the equation results against the portfolio data and the environment and hazard data. This combines the portfolio and GIS data for loss processing in the Loss Calculation Engine.

The formulas for loss calculation may be enhanced by the administrator using the Formula Editing 192 feature. The user may also save and recall previously saved Model simulations. The application further utilizes a combination of Monte Carlo processing 198, Grid computing 200, Parallel computing 202, and Cloud computing 204 for the model simulations. While other applications use these approaches to simulate models from beginning to end, the present invention allows the user to select the model's path and range and only completes the model simulation using a combination of the above-mentioned approaches. In order to execute and simulate models, the application may use the approaches to obtain fast results. Damage data for the claims in the simulated regions are calculated. This Claims Data 224 is saved for future claims generation. Friend Models 206, models that are associated with a simulated model, are also loaded. When the user is setting the model attributes, the user may select an option to indicate whether the user would like to see associated layers of the model. Associate model layers are the friend module of the model being simulated, if applicable. Friend Models 206 are drawn and have their attributes automatically calculated based on the parent model's attributes. The administrator may specify which friend of what event can always be seen, or based on severity, may be configurable for showing set conditions on when to show friend models. Reinsurance treaties are applied to a simulation to view their effect on the map based on the conditions.

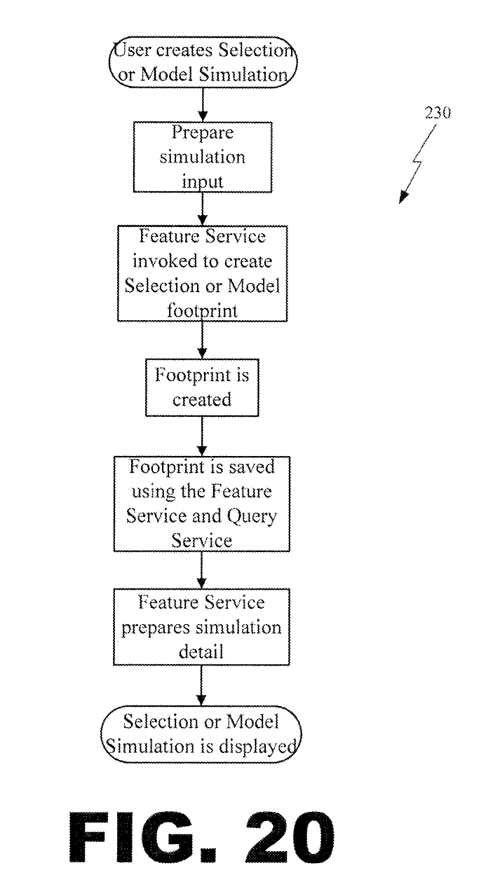

FIG. 20 is a flow diagram illustrating one example of how a simulation is created in the present invention. The user first simulates a selected Model or creates a Selection on the browser. Once the simulation input is complete the Feature Service is invoked to save the simulation storing any generated footprints. The footprints are then displayed in the browser as a single simulation layer (the Selection or Model is displayed on the active layers). Next, the Query Service, Loss Calculation Service and Data Analytics Service come in to provide risk analysis. The Query Service finds the overlapped risks from the Simulation Detail (footprints in the simulation). Risk Statistics are then prepared for Spatial Analysis. The prepared Risk Statistics data is retrieved and the Loss Calculation Service then calculates estimated loss from affected risks for the Model footprints in the simulation. The prepared Risk Statistics is updated with the estimated loss amount and Risk data is displayed in Data Analytics.

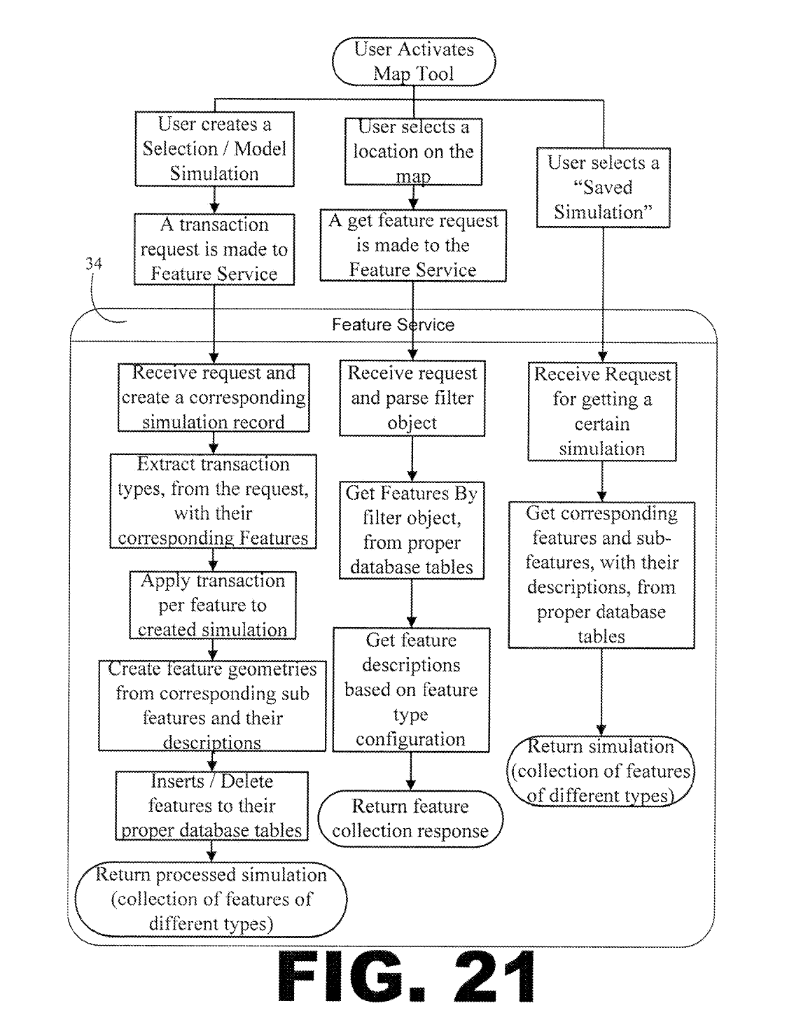

FIG. 21 is a flow diagram of the Feature Service illustrating examples of how simulations are created, updated and deleted, how a feature may be obtained, and how a previously saved simulation may be recalled. The Feature Service 34 allows users to communicate spatially with their data store. Geographic Markup Language (GML) is the xml standard used to describe geographic data from and to the service. Three main requests may come to the Feature Service Transaction Request (Insert, Update and Delete), Get Feature Request and Get Simulations. Other requests may get different feature types and sub feature types with their descriptions if available to a user, or getting data associated with those features from different layers based on spatial requests. The Transaction Request is responsible for creating, updating and deleting simulations. A simulation is defined as a group of features, possibly of different types. Each feature is composed of multiple sub features (ex. A tropical cyclone feature can be composed of seven sub feature types, “TD”, “TS”, “H1-H5”, while a selection feature is composed of one sub feature type, “shape”). Each sub feature may be associated with necessary configuration to help in loss calculations and/or querying the features. The User first models or draws some features on the map, using the selection tool or some modeling tool then saves the simulation. A Transaction Request is generated by the feature service client and sent to the Feature Service 34. The Feature Service 34 receives this request and creates a corresponding simulation record for it. The Feature Service 34 then processes each feature in this simulation by inserting, updating or deleting what is required. From each feature in the request, the Feature Service 34 creates the proper geometries, from the corresponding sub-features, with the corresponding feature and sub-feature descriptions (which are either provided by the user or generated by the system). Some feature types, like Selection simulations, requires the Feature Service 34 to perform further geometric processing, after the transformation from the GML, on their sub-features (the Selection “shape”) to give a proper final result based on the user's input. Other feature types are treated with straight through transformation to their corresponding geometries. The Feature Service 34 then inserts and deletes features to their proper database tables (based on configuration, each feature type may have its own database table or may share the same table). Finally, the Feature Service 34 returns a resulting a notification response which may include the corresponding simulation's feature collection, with its sub features and their description, when required.

The Get Feature Request of the Feature Service 34 gets a feature with its configured description from a layer in the database. The user first selects a location on the map using the Map Tools (Or user may select a group of locations at once). A Get Feature Request is generated and sent to the Feature Service. The Feature Service 34 processes the filter object associated with the request, if any, and applies it to the proper layer, pre request type to retrieve the corresponding applicable features. A set of user parameters can further filter out those features and/or possibly alter their geographic composition. The service transforms those feature geometries to the proper GML. Finally, the service returns a feature collection response to the user. This feature collection may include feature specific information based on user or system configuration.

The Get Simulation Request of the Feature Service 34 gets a simulation with all of its features from the database. This is utilized when the user would like to work with a previously saved simulation. The User first tries to load a saved simulation. The Feature Service 34 is called with the corresponding Simulation ID. The Feature Service fetches all the underlying features, from multiple tables in the database, with their corresponding input parameters and sub feature parameters (similar to fetch behavior in the get feature request mentioned above). The Feature Service 34 then returns a feature collection response with any corresponding simulation information.

In FIG. 16, the Models module contains a Loss Calculation Service 38 to calculate and generate the estimated loss for the user simulated model. The factors the Loss Calculation Service 38 utilizes when calculating loss may include Inventory, Financials, Historical Loss, Models, Hazard Inventory, Environmental Variables, and Model Inventory. Inventory are attributes which are taken into consideration for calculating loss such as location, construction code, year built and socio-economic conditions as discussed above. Financials are the attributes that are affected for each risk in the portfolio. The attributes which are considered are deductibles, coverage, limit and content of the risk. Historical Loss is the loss experienced or the claims that are observed for each type of model. A Post-Model Simulation Factor is arrived at to help calculate the loss by multiplying this factor to achieve the estimated loss at a location to receive more accurate data. The Models are attributes that assist in faster computation. The parameters, intensity, time element and type of each model are factored. Hazard Inventory is the frequency that is calculated. Environmental Variables are the attributes that are based on the environment such as terrain, elevation, geometry, landslide succesibility factor and CRESTA. Model Inventories are the generalized and standard attributes that can be used for more than one model such as over pressure, wind, fire and landslide.

This application further follows a Loss Calculation Methodology 210 when determining loss. The methodology involves Pre-Model Characteristics 212, Model Characteristics 214 and Post-Model Characteristics 216. Pre-Model Characteristics 212 are the attributes of a structure at a location which can be predetermined. These factors are calculated and calibrated to formulate an index that can be used to derive loss estimates when applied to the model event.

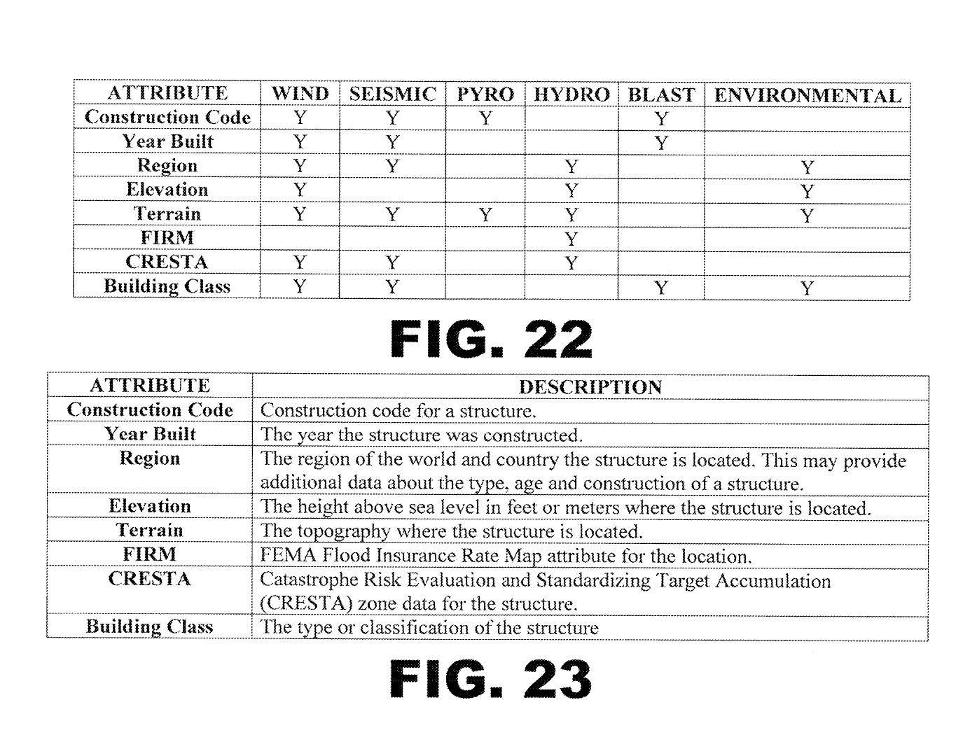

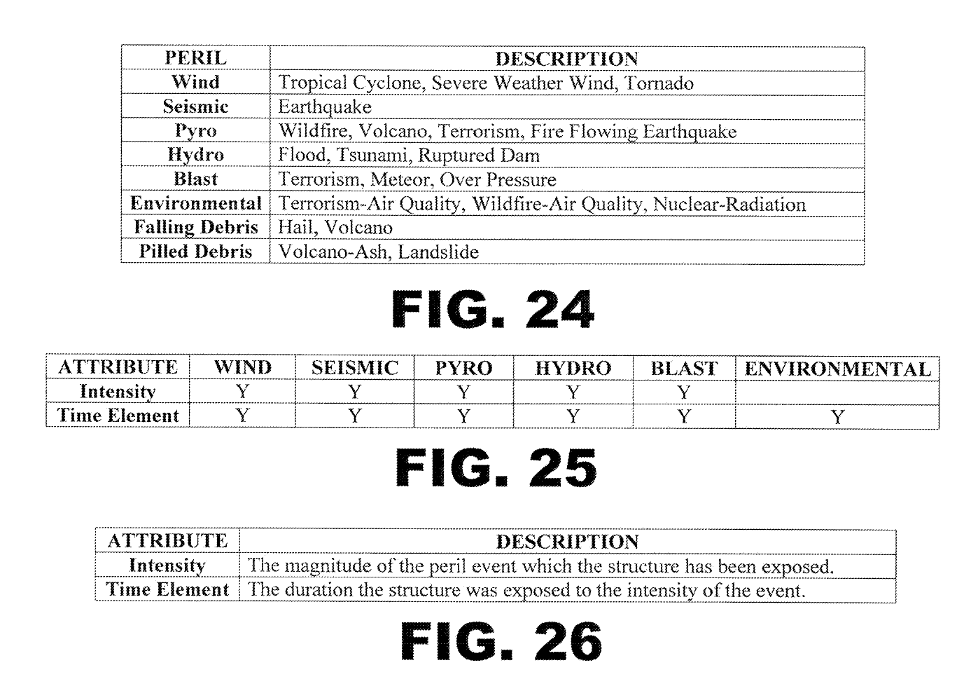

FIG. 22 is a table of the type of model and the Pre-Model attributes that are considered for each model. A “Y” indicates that the attribute is a factor for the model. For example, the construction code of a structure is a factor when the structure is exposed to a model that produces wind, seismic, pyrotechnic (pyro) and blast events. FIG. 23 is a table illustrating pre-model attribute descriptions and FIG. 24 is a table illustrating model descriptions. The attributes which may be considered are Construction Code, Year Built, Region, Elevation, Terrain, FEMA Flood Insurance Rate Map attribute for the location (FIRM), Catastrophe Risk Evaluation and Standardizing Target Accumulation (CRESTA) and Building Class.

Model Characteristics 214 are the attributes of an event at specific locations which may be determined at the time the event is simulated. These factors are used to derive loss estimates when applied to the model event. FIG. 25 is a table of the type of model and the Model attributes that are considered for each model. A “Y” indicates that the attribute is a factor for the model. For example, the intensity of an event is a factor when the structure is exposed to a model that produces wind, seismic, pyro and blast events. FIG. 26 is a table illustrating model characteristic attribute descriptions. The attributes which may be considered are Intensity and Time Element.

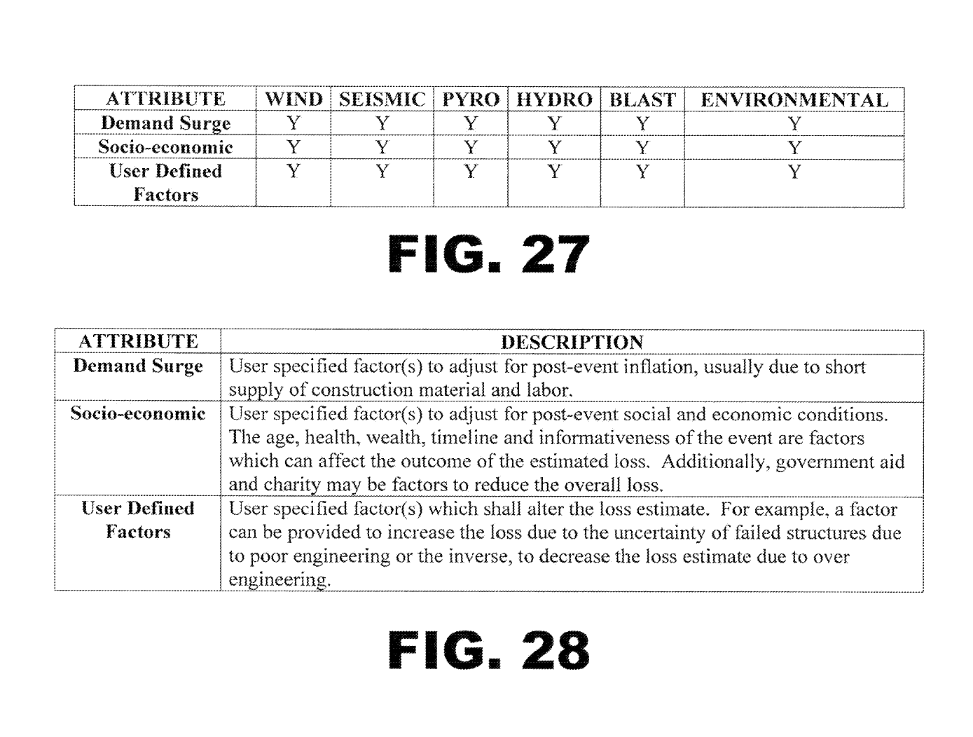

Post-Model Characteristics 216 are the attributes of an event at a specific location which occur after the event is simulated. These factors are used to adjust loss estimates when applied to the model event. FIG. 27 is a table of the type of model and the post-model attributes that are considered for each model. A “Y” indicates that the attribute is a factor for the model. For example, the Demand Surge for an area is a factor when it has been exposed to a model that produced a shortage of supplies and labor to rebuild an area. FIG. 28 is a table illustrating the post-model attribute descriptions. The attributes which may be considered are Demand and Surge, Socio-economic and User Defined Factors.

Within the Loss Calculation Methodology 210 is a Damage Methodology 218. This Damage Methodology 218 consists of the Vulnerability Matrix 220 which captures the probability of damage for a structure type and its construction code for a given model event and intensity in a user specified region. For example, when analyzing a United States location, the probability of an earthquake occurring on or near the western coastline is much greater than the rest of the U.S.; the probability of a tropical cyclone occurring on or near the eastern coastline is much greater than the rest of the U.S.

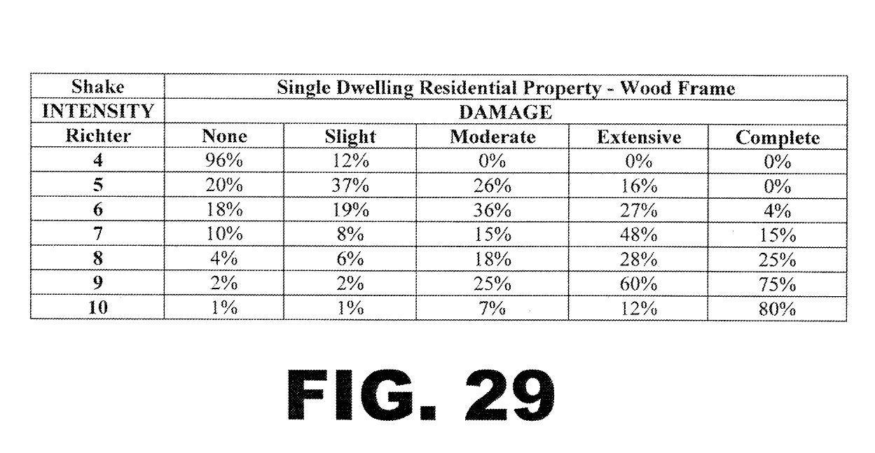

FIG. 29 is a table illustrating the Vulnerability Matrix for a Seismic model. As applied to the present invention, the Vulnerability Matrix 220 captures the probability of damage for a structure and its construction code for a given peril event and intensity. The Vulnerability Matrix 220 for each category of model shall be different. The expected annual economic loss can be estimated using the equation:

L=ΣᵢF(I)ΣₖP(D_{K}|I)R(K)T

Where the Estimated Loss (L) can be derived using the Total Insured Value (T) and resulting Intensity (I) from a simulated model. F(I) is the frequency of the intensity I at a site, K is the damage category, R(K) is the mean loss ratio to the site if it suffers damage category K, and P(D_{K}|I) is the probability of the event.

The Query Service 36 implements some of the features of the Loss Calculation Service 38. One of the major features is to find and calculate the affected and overlapped policies using spatial ware functions. A stored procedure, executed by the Query Service 36, calculates loss by using an inline function. A Historical Loss Service 222 helps calculate the gross loss amount. The design is able to scale and hold AAL for a model's intensity, model return period and location such as a grid cell, zip code and county.

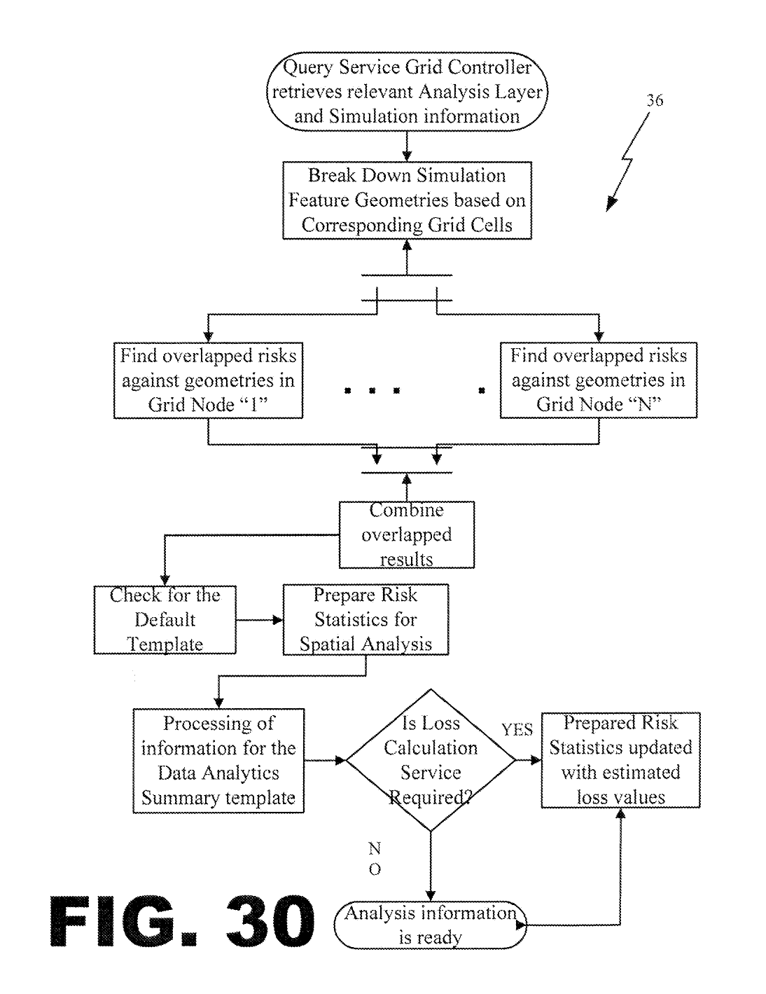

FIG. 30 is a flow diagram of the Query Service illustrating one example of how risk data processing of a simulation occurs in the present invention. Once the Feature Service has returned a feature collection response, representing a simulation to the user, the Query Service Grid Controller of the Query Service 36 is invoked and retrieves relevant Analysis Layer and Simulation information. The controller then fetches the feature geometries associated with the simulation and spatially breaks down theses geometries based on its configured geographic grid. The controller then assigns each shape to a cell in the grid. The grids' cells, which are different geographic regions within the grid, represent different Query Service Nodes which contain identification references of the business data in that cell (region). In parallel, the controller calls all applicable grid nodes (based on the bounds of the simulation features), to fetch the overlapped analysis layer feature references (ids) in that cell (region). Each grid node then returns the list of overlapped feature references with the simulation shapes in that region. After all grid nodes completed returning results, the controller finally combines theses results into one set. The Query Service Grid Controller 36 checks for the default template of the layer being analyzed and accordingly, prepares proper Risk Statistics information corresponding to the overlapped features.

In FIG. 16, the models simulated by the user are for the purpose of obtaining loss values to the portfolio. The Loss Calculation Engine 208 of the Loss Calculation Service 38 is used to determine the amount and type of loss the portfolio will receive. Within the Loss Calculation Engine 208 are calculation formulas specific to each model based on each model's characteristics and a loss calculation grid service. The databases included in the Loss Calculation Engine 208 are Model Inventory Database, Hazard Inventory Database, Inventory Database, Financials Database, and Environmental Variables GIS Database.

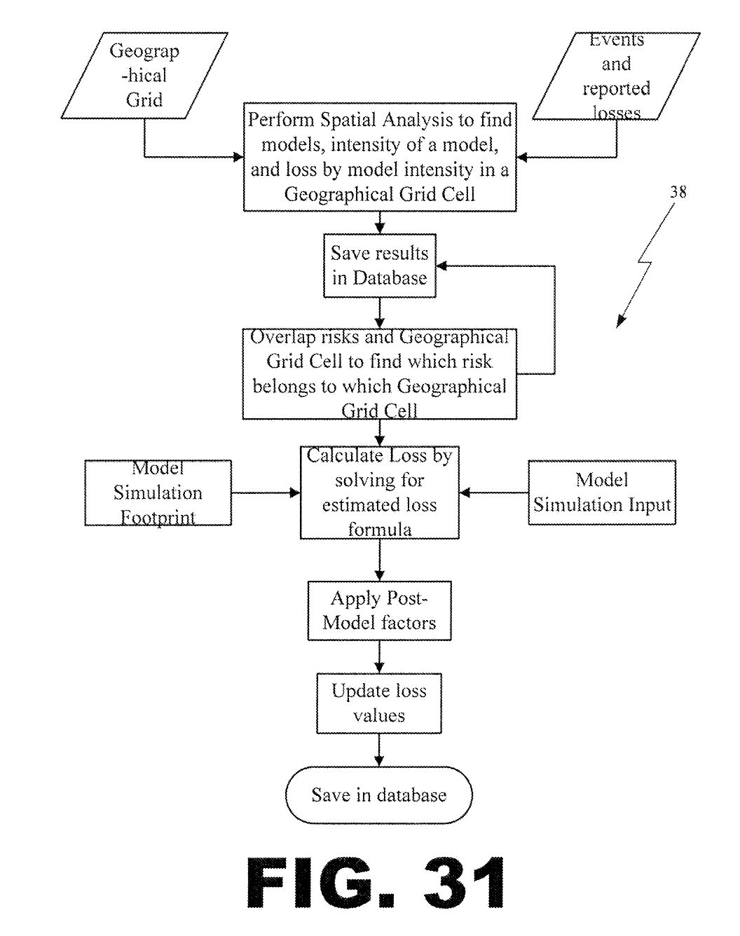

FIG. 31 is a flow diagram of the Loss Calculation Service illustrating an example of loss calculation in the present invention. A Spatial Analysis is performed on a Geographical Grid and Historical Events and Reported Losses to find models, intensity of models and loss by the model's intensity in a Geographical Grid Cell. These results are saved in a database. Then the risks and Geographical Grid Cells are overlapped to find which risks belong to which map cell. These results are saved in a database. Loss is then calculated for the overlapped risk data by solving the estimated loss formula for the Model Simulation footprint and Model Simulation Input. The Post-Model Characteristics 216 are applied to the estimated loss. Loss values are updated and saved, invoking the Data Analytics Service allowing the risk data to be displayed.

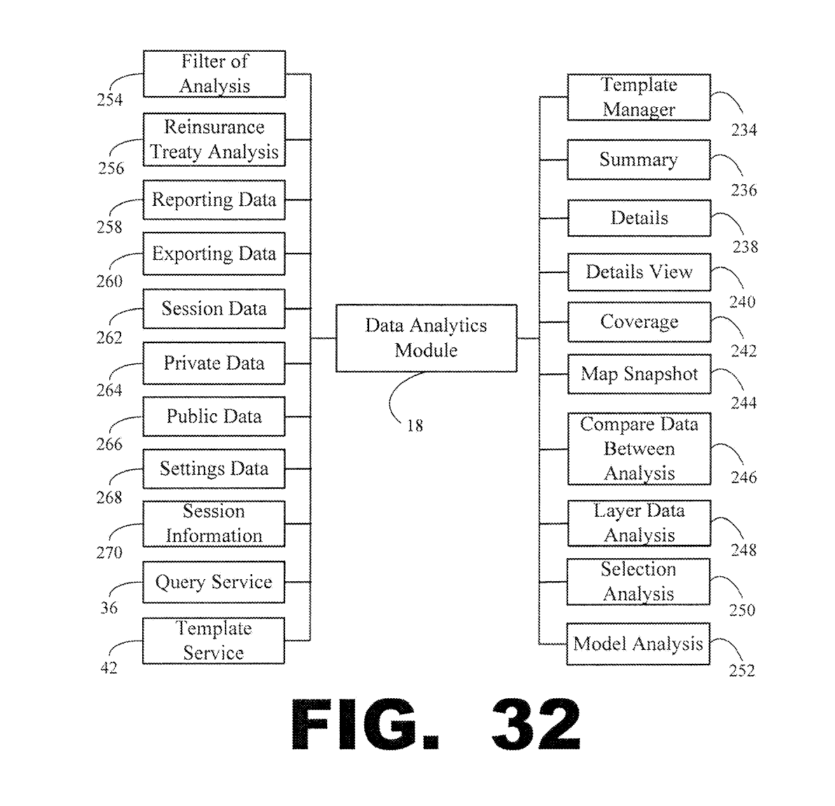

FIG. 32 is a chart illustrating the features of the Data Analytics Module of the present invention. Data Analytics is the representation of data for the events which affect the portfolio and data for the user performed actions on the map. The overlap of these events, actions and its effect may be seen. The current value of the risks, either on initial log in to the map or after user manipulation of events, may also be seen here. The Data Analytics' GUI application is available to administrators and users. The Data Analytics module 18 allows the user to perform analytics with the data either self populated or generated by the map or by the user interface. This module allows for grids with controls which run two modes: Read-Only Mode which allows for viewing only, or Edit Mode which allows for the editing of the grids with EXCEL services functionality.

Within the Data Analytics module 18 are features allowing the user to customize the type of data that is presented. The data is presented in a dynamic, multi-dimensional format which allows for the speedy presentation of only user needed and desired information in any of the layers, rather than presenting the user with all of the affected portfolio data and forcing the user to drill down through thousands of criteria until the user sees the desired data.

The Template Manager 234 provides different kinds of templates with which to view the data. A wizard helps the user generate reports in an output format that is specific to the user and user roles. This feature allows the administrator to configure a default template for viewing the data interface layout in the Data Analytics module 18 and set one as a default template for the role or user level. Each user has a default template structure. A template manager UI provides a centralized location which is responsible for configuring templates for a layer, making maintenance easier. The UI helps the user visually create or modify the template structures. Based on the layer being requested, the template manager provides the configuration details for Summary 236, Details 238, and Details View 240.

Once all the default settings have been selected by the administrator, and the user has performed a Selection or Model Simulation, analysis information is created for the user configurable default analysis layer and default template in the Data Analytics module 18. The Selection or Model Simulation is overlayed on the analysis layer, and the data derived from this action is presented in Summary 236, Details 238, and Details View 240. Once the initial analysis is completed, user may change the default analyzing layer, change the default template, or create filter conditions within Data Analytics. For example, if the administrator had initially configured the default analysis layer to be risk locations and the default template to only present states or providences, the user may now change the analysis layer using the Select Layer 278 feature and default template using the Select Template 280 feature to present different data. Furthermore, the use may create and save additional filters to filter the analysis using the Filter 254 feature to pinpoint the exact pieces of data that are needed.

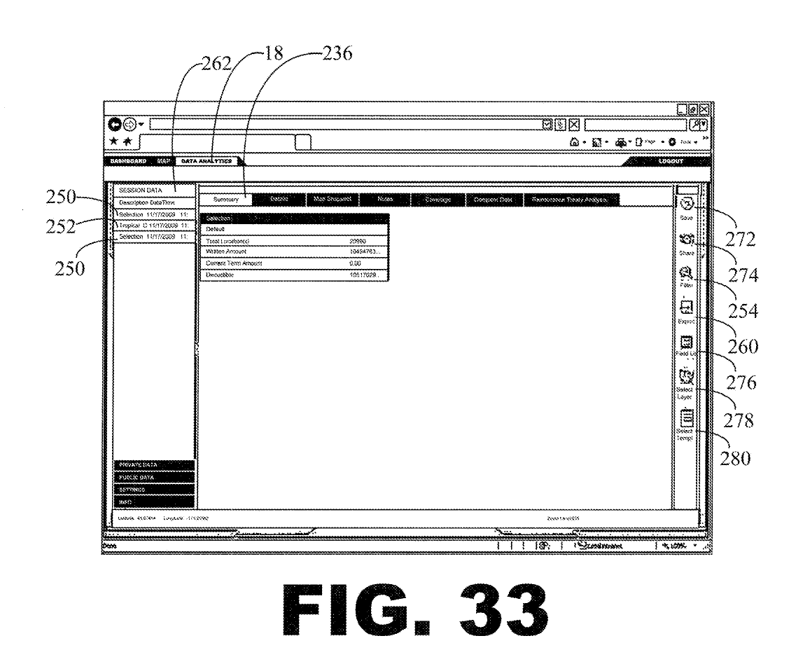

FIG. 33 is a screenshot illustrating the Data Analytics features of the present invention. The Summary 236 feature gives a summary of the user performed actions on the map. This may include any user Selections or Model simulations.

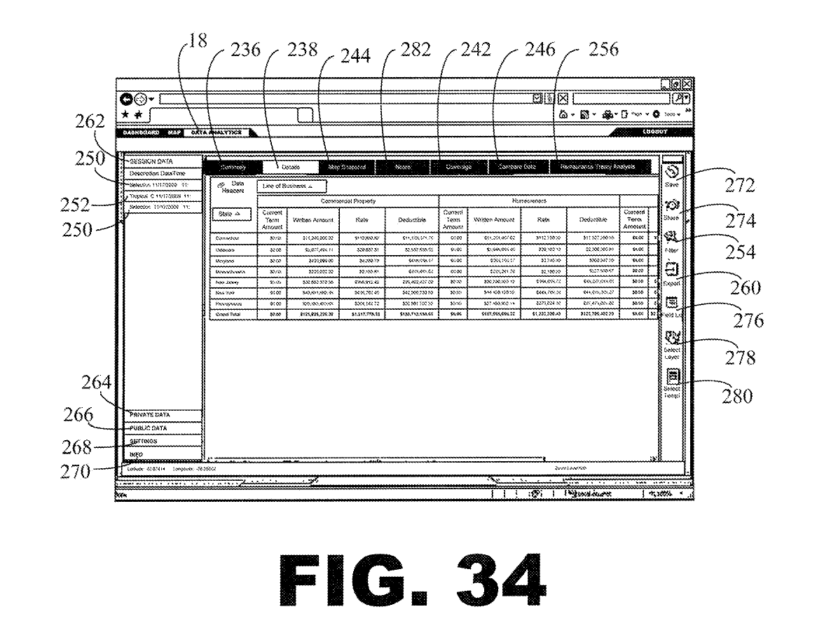

The user may use the Details 238 feature to obtain data analysis information for each analyzable layer. FIG. 34 is a screenshot illustrating the Details feature of the present invention. The Details 238 feature presents risk information for any selection the user has created or any model actions performed on the map. The affected data is presented here. The data is displayed in a tiered format for which user may organize according to user preference to obtain the desired data. The user may jump among and change around the data tiers without having to drill down through the data in any specific order to find the needed data. Hence, this Details 238 feature is flexible and gives the user a multi-dimensional view of the portfolio to accommodate the user's needs.

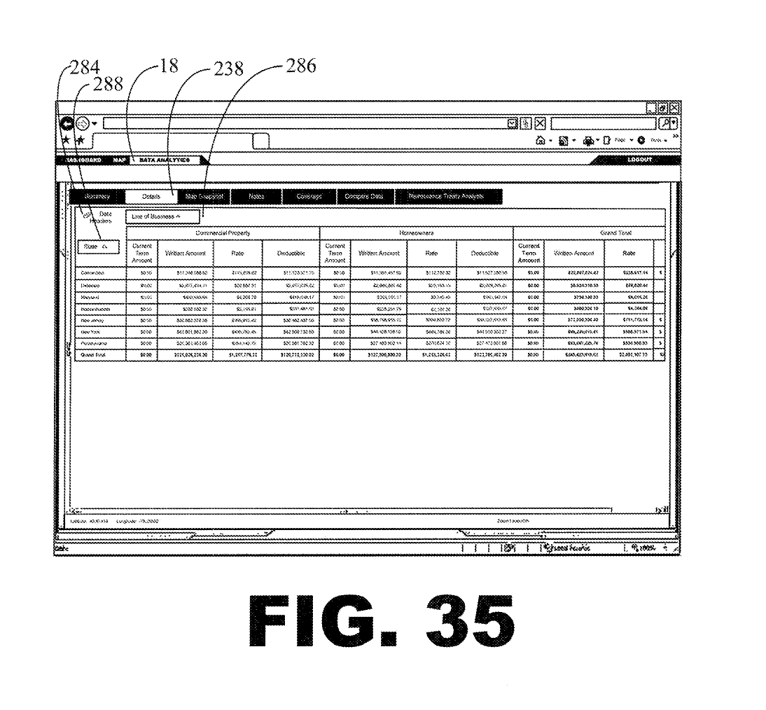

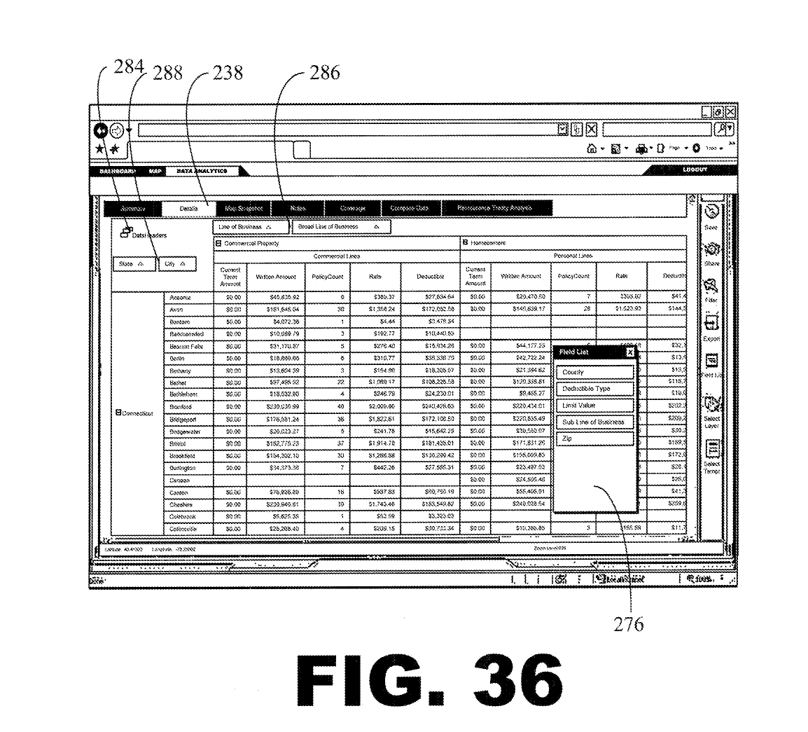

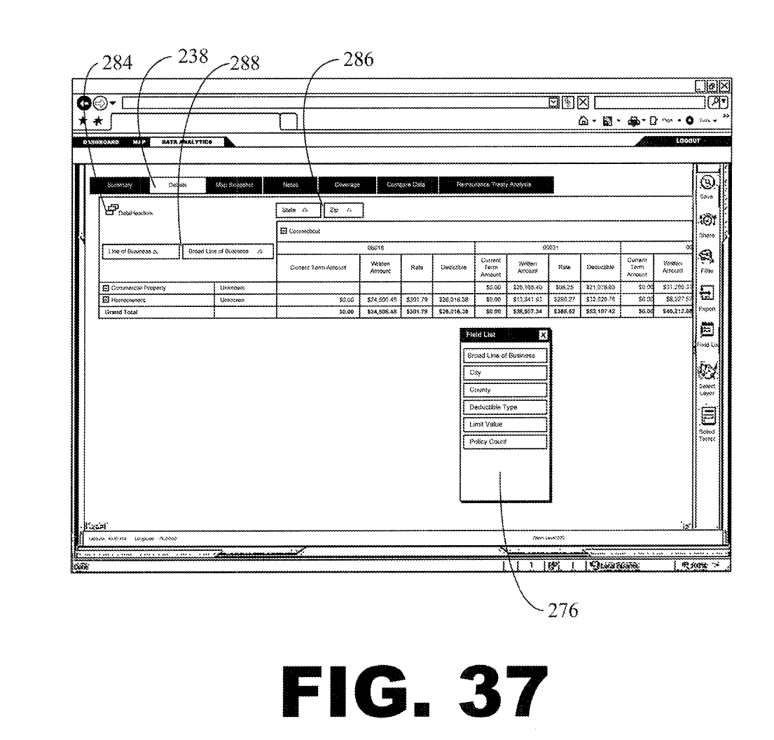

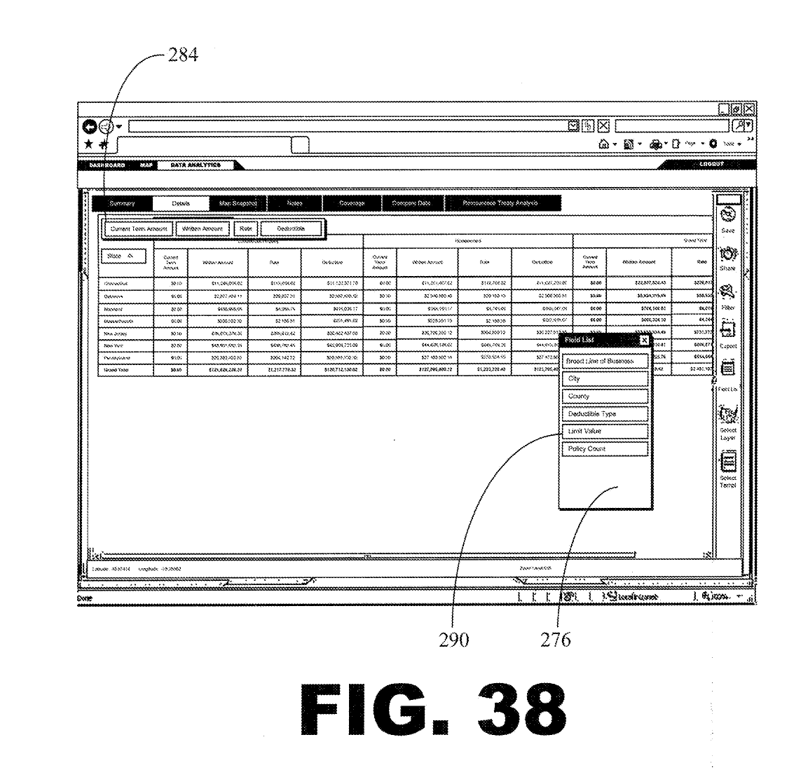

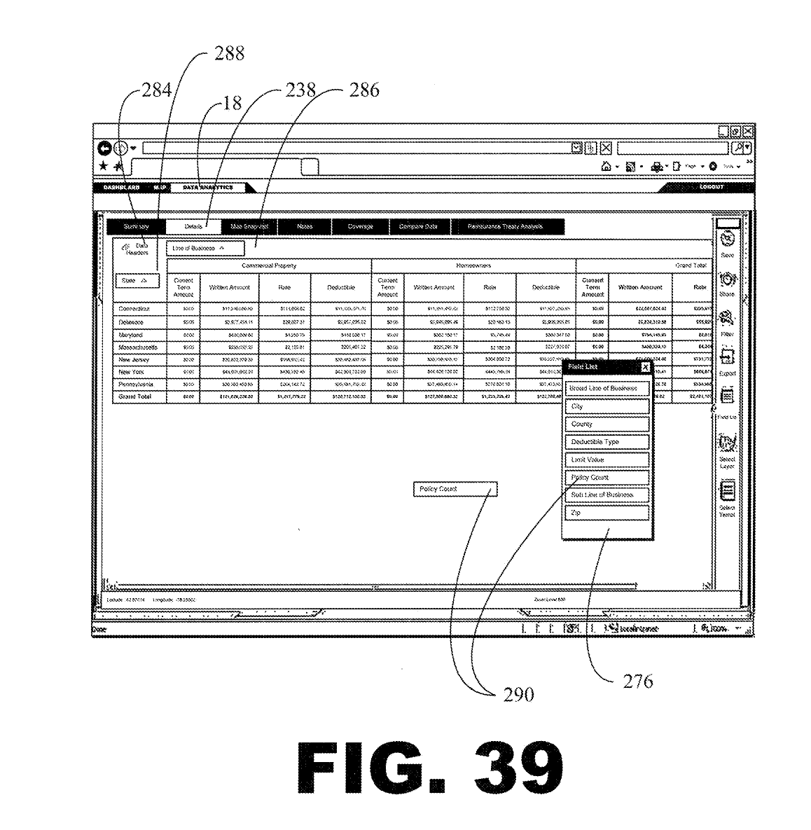

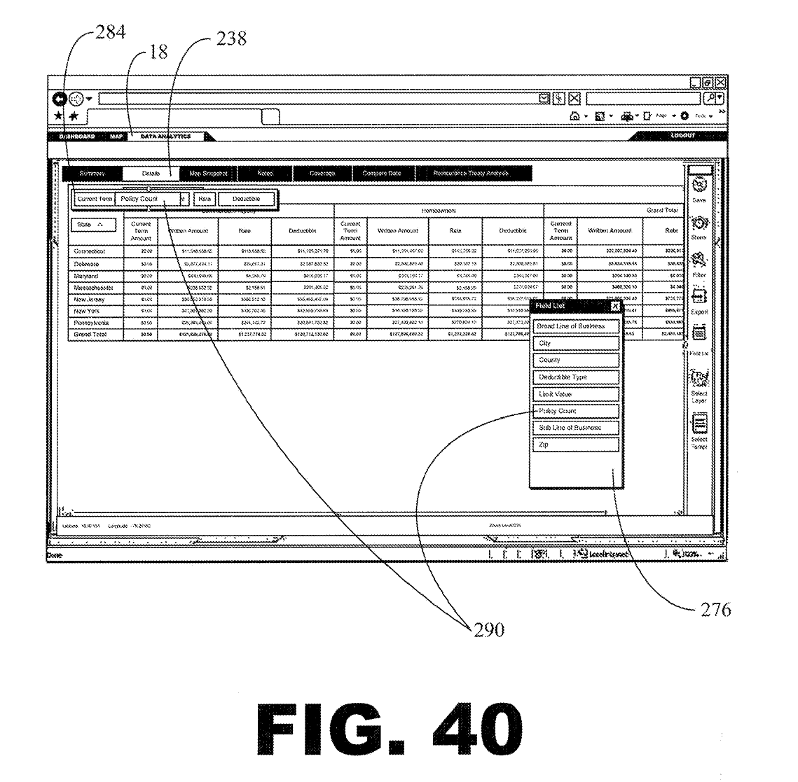

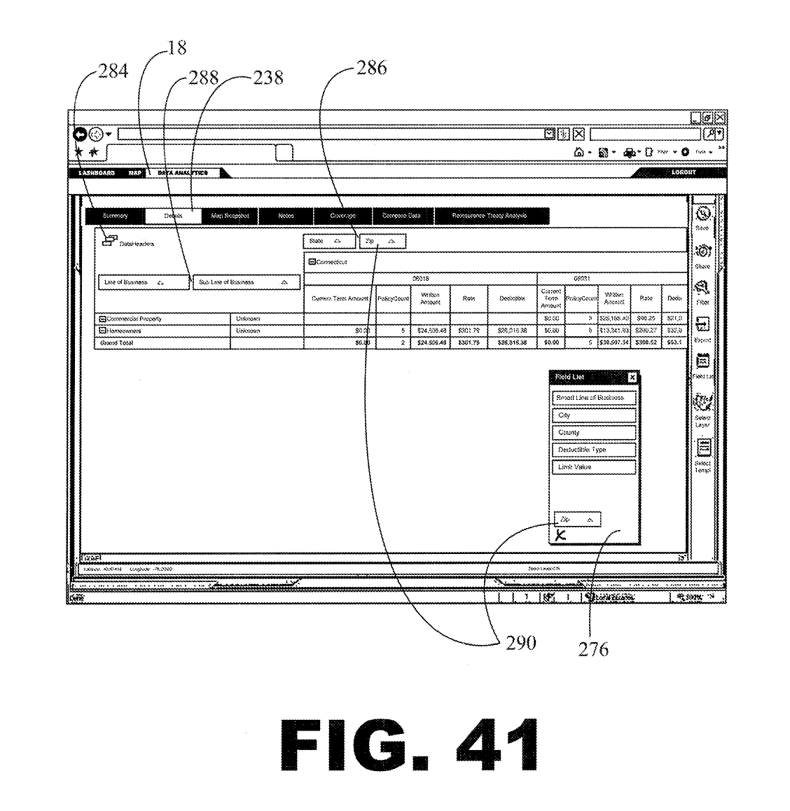

FIG. 35 is a screenshot illustrating the Data Header 284, Column Header 286 and Row Header 288 of the Details 238 feature of the present invention. FIGS. 36 and 37 are screenshot illustrating of the rearranging of the Header categories 290. FIGS. 38, 39, and 40 are screenshots illustrating the addition of a category to the desired Header position from a Field List 276. FIG. 41 is a screenshot illustrating the removing of a Header category290 from a Header into the Field List 276. The user selects the desired categories to be displayed from a Field List 276 and places the Header categories 290 in either the Data Header 284, Column Header 286, or Row Header 288 area to receive that piece of information in that particular placement which user has selected, and the corresponding data will appear exactly how the user would like to see it. The user may add, delete and rearranged the Header categories 290 in any of the Data Header 284, Column Header 286, Row Header 288 and Field List 276.

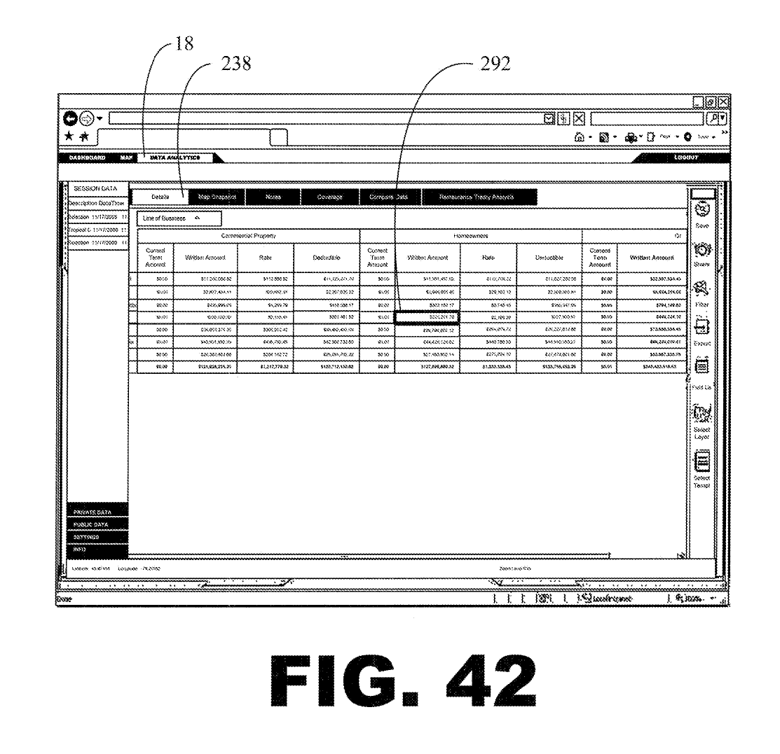

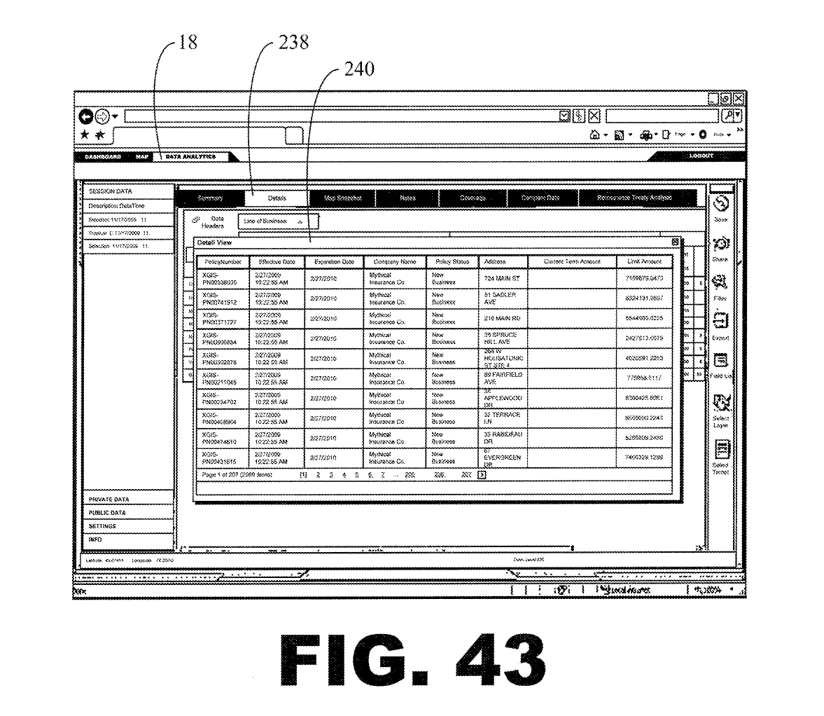

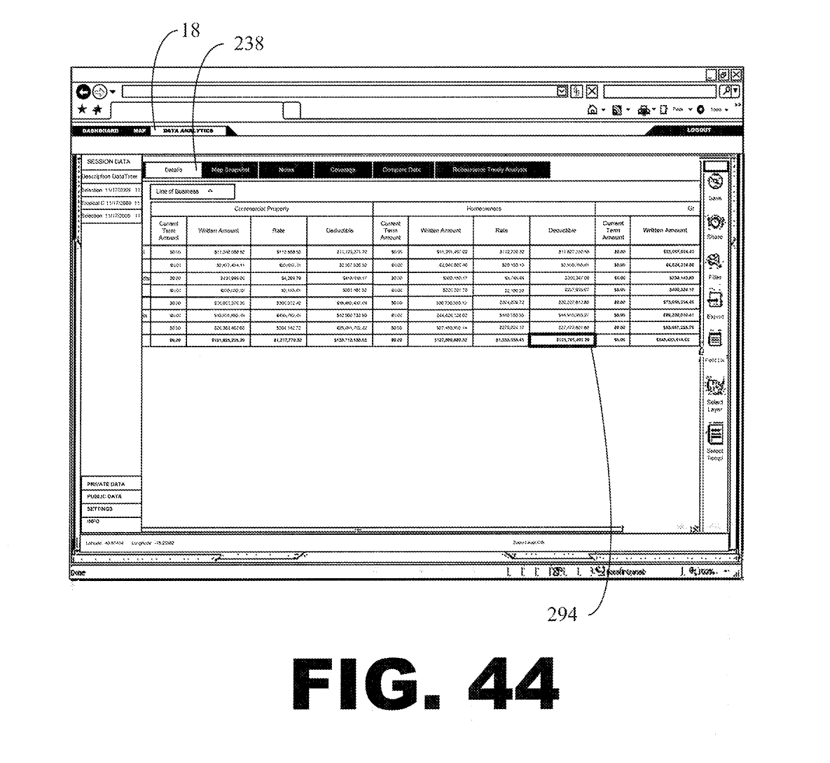

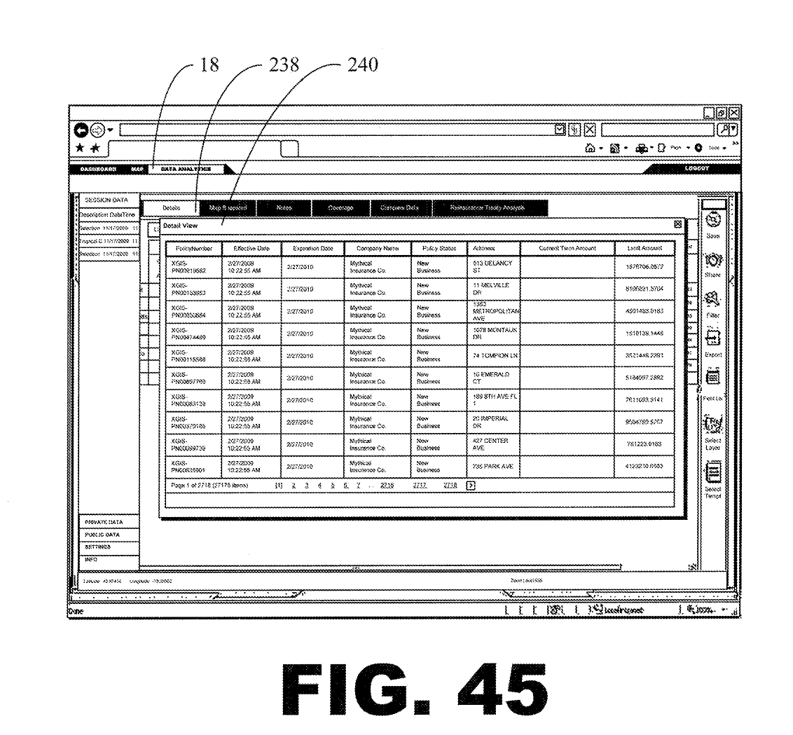

Furthermore, any cell selected within the table provides specific data pertaining to that cell in Details View 240. FIG. 42 is a screenshot illustrating a cell selection 292 in the Details 238 feature for display of Details View. When the user selects this cell, a Details View appears. FIG. 43 is a screenshot illustrating the Details View 240. The user may also create a group selection within the Details feature. FIG. 44 is a screenshot illustrating the selection of a group cell in the Details 238 feature for display of Details View. Upon selection, a Details View 240 appears, FIG. 45.

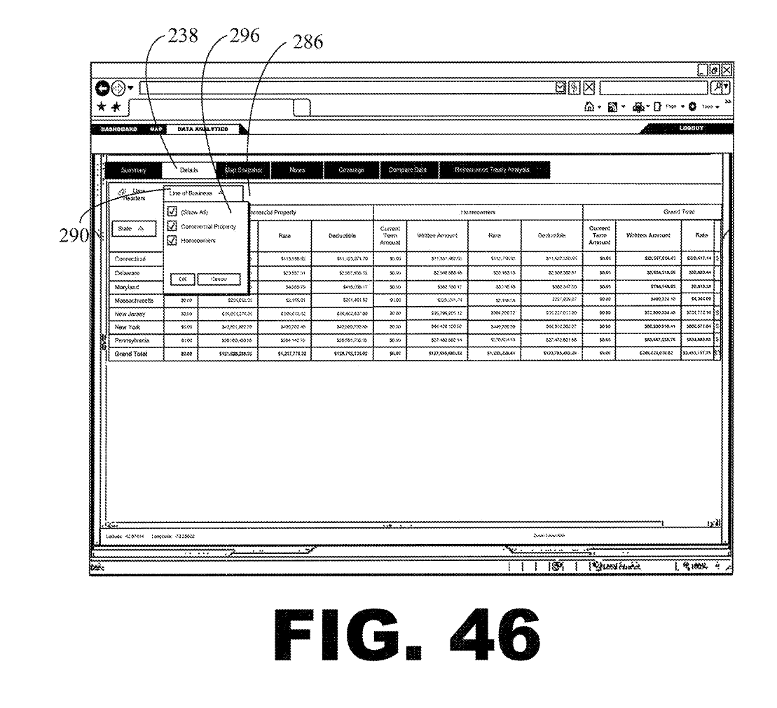

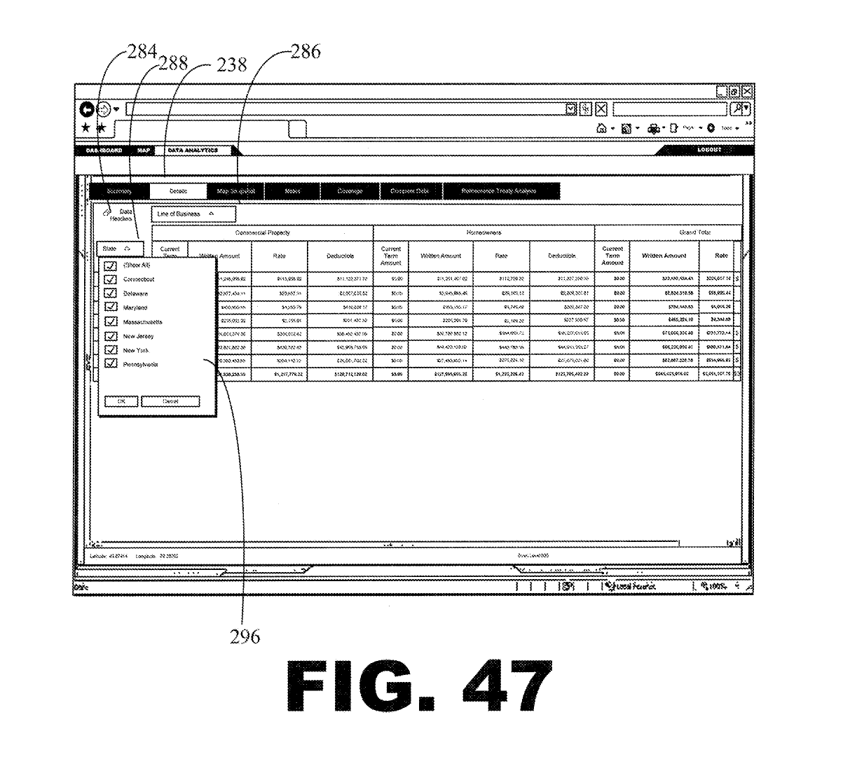

Any Header category 290 that user requires may be configured into the Field List 276. The Header categories 290 in the Field List 276 may include, but are not limited to: current term amount, written amount, rate, deduction, line of business, sub-line of business, broad line of business, world, continent, country, state, providence, city, county, zip and postal code, and risk. Once these categories are placed in the user selected Headers, the Header categories 290 may be further customized. FIGS. 46 and 47 are screenshots illustrating the sub-categories 296 of each Header category. FIG. 46 shows the sub-categories 296 for the Line of Business Category. FIG. 47 shows the sub-categories 296 for the State category. Each Header category has sub-categories 296 which user may select or unselect for more precise and specific data presentation. For example, if user has placed the State category in a Header, the user may select from a list the exact state or states which are applicable. Another example, if user has placed the Line of Business category in a Header, the user may select needed types of risks to be displayed instead of all of the possible types of risks.

In FIGS. 33 and 34, the Coverage 242 feature describes the types of coverage that are specific for model simulations. The application determines default coverage in each model simulation case. The user is able to view and chose from available coverage.

The Map Snapshot 244 feature gives the user a snapshot of user performed actions on the map, which is shown in the Data Analytics feature on the map session area. An image of the map with the selection done on that region is shown here. The Map Snapshot 244 is available when the user exports current level data or all policies level data.

The Compare Data Between Analysis 246 feature shows the underwriting statistics generated from using other features that are available to the user. The type of coverage that is specific to model simulations are shown here.

Using the Layer Data Analysis 248 feature, the user is able to choose layers from the application's Layer Catalog for analysis. The user is able to analyze any layer's information in the application. The user may further choose the data which is used for analysis. The layers that are present in the current selection are available to analyze the data. The user is also able to save the analysis results for future use.

Data analysis according to the Selection created by the user is accomplished using the Selection Analysis 250 feature. The user is able to analyze data which is generated by performing any kind of Selection and any Models. The user may choose the data which is used for analysis from both simulation results and saved layers from the application's Layer Catalog. The user is able to analyze policies by catastrophic events, dynamic hazard (real-time events via web feeds) events, the line of business selected, and exposure simulation in the application. Furthermore, the user is able to create formulas by using a formula builder feature for further data analysis. The user may define formulas for model analysis. For example, the user may define a formula for claims generation specific to the user. The user is able to save the analysis results the same as user may save any selections or model simulation results.

When the user creates a model simulation, data is generated for further analysis using the Model Analysis 252 feature. The user is able to simulate models which generate data to be saved for claims generation for reinsurance and insurance companies.

Using the Filter of Analysis 253 feature, the data analysis is reflected according to the filter being applied for the current view on the map. A display of the current filter and whether the filter is active or inactive appears. Users may refine or enhance the selected filter and breakdown the filter into several ranges if the filter is numeric or when applicable. The data is then displayed in these user selected ranges.

The Reinsurance Treaty Analysis 256 feature shows the user the reinsurance program. In the case of a simulated event, the user sees the catastrophe program. This analysis presents the effect of a simulation on a treaty. The user selects a treaty from the treaty manager. The treaty manager allows the user to create a new treaty and define the treaty type, coverage that applies and other rules that are concerned with reinsurance treaties. Furthermore, the user may add reinsurers who may participate on a treaty. The user may assign these reinsurers to the layers of a treaty and the percentage they have agreed upon based on the type of treaty. These treaties are viewable on the map following a simulation.

The user may save the Data Analytics analysis session as displayed by the user and share the session with other users or organizations.

The user may also export the data that is loaded in the report and template grid into an EXCEL file using EXCEL services. The user may select the data for export and modify the style, or layout, in a result spreadsheet before exporting. The user may also use the Reporting feature to export the data being analyzed for further reference. The application provides a centralized location that is responsible for exporting data information, such as a folder from the application common service onto a SHAREPOINT site. The user may export the data either by current level or detailed level. When the current level option from the Data Analytics page is selected, all the data that is displayed in all the features are exported to a SHAREPOINT folder. On selecting the detail level option, the data will be exported to a SHAREPOINT site. The fields that are exported are based on the selection of fields.

For quick access to session information, the user may utilize the Session Data 262, Private Data 264, Public Data 266, Settings 268, and Session Information 270 folders. The Session Data 262 folder displays a list of the user actions on the map which the user has analyzed. Depending on whether or not the User shares the specific Data Analytics analysis sessions, the user actions are also displayed in either the Private Data 264 or Public Data 266 folders. The Settings 268 folder allows the user to configure the settings which are also available in the Administrative and User Settings Module which pertain to Data Analytics.

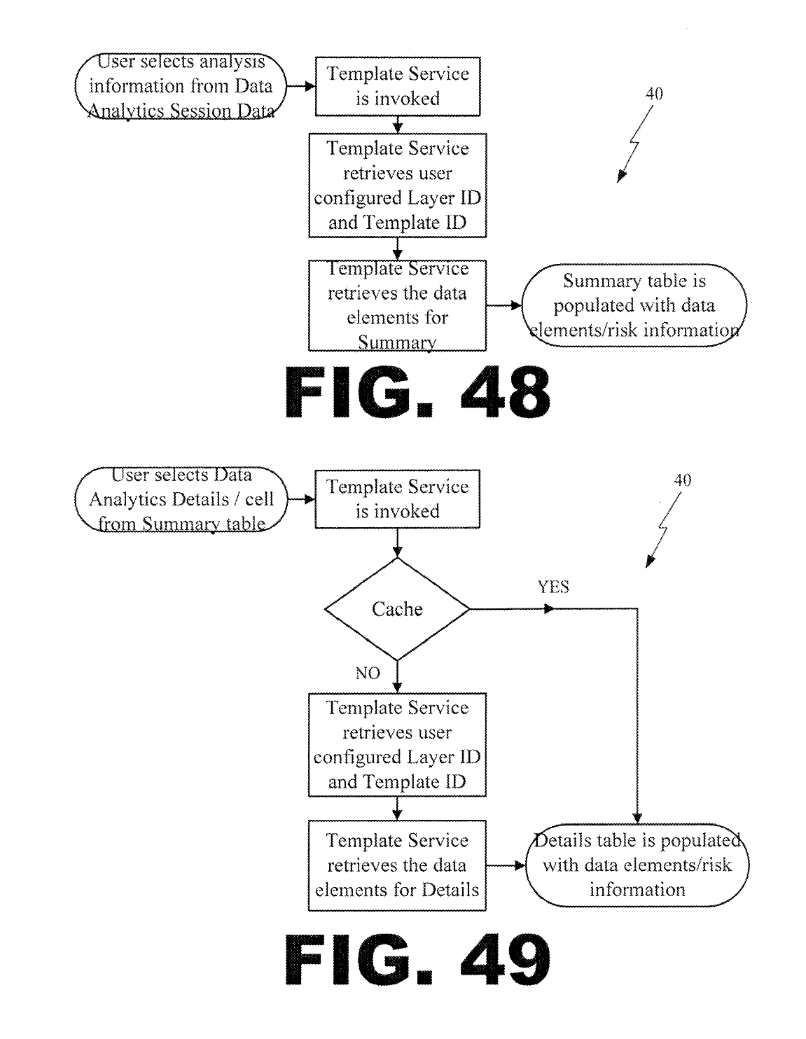

FIG. 48 is a flow diagram of the Data Analytics Service of the present invention illustrating one example of data population of the Summary feature. Once the Feature Service, Query Service, and Loss Calculation Service have been completed, the user may select a simulation session from the Session Data section of Data Analytics. This selection invokes the Template Service, which retrieves the Layer type and Template type. The Template Service retrieves the data elements for Summary and populates the Summary information.

FIG. 49 is a flow diagram of the Data Analytics Service of the present invention illustrating one example of data population of the Detail feature. The user first selects Details or a cell from the Summary feature. This selection invokes the Template Service and repeats the above steps or cache. The Template Service retrieves the data elements for Details and populates the Details information.

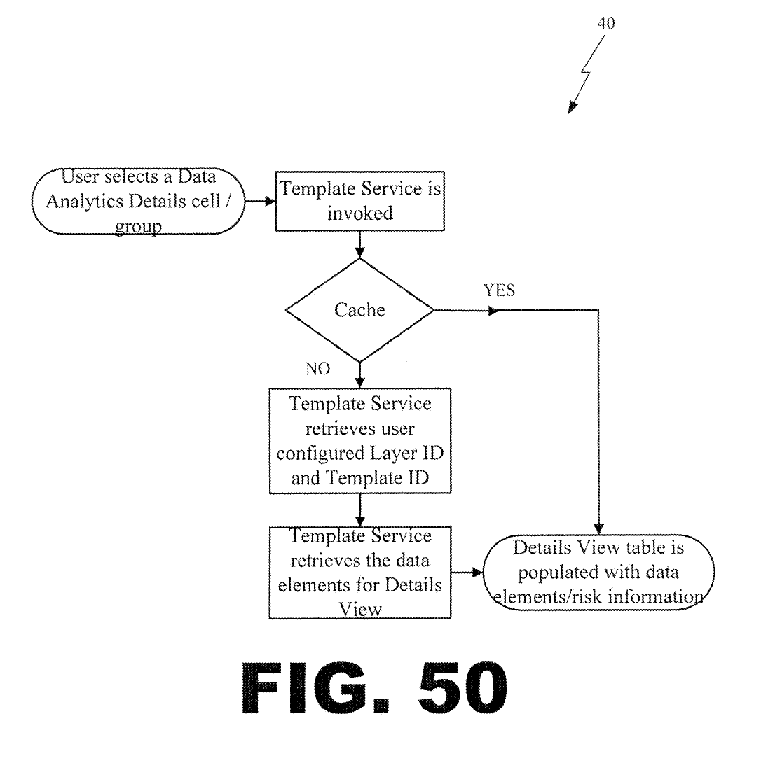

FIG. 50 is a flow diagram of the Data Analytics Service of the present invention illustrating one example of data population of the Details View. The user first selects a Details cell or group cell within Details. This selection invokes the Template Service and repeats the above steps or cache. The Template Service retrieves the data elements for Details View and populates the Details View information.

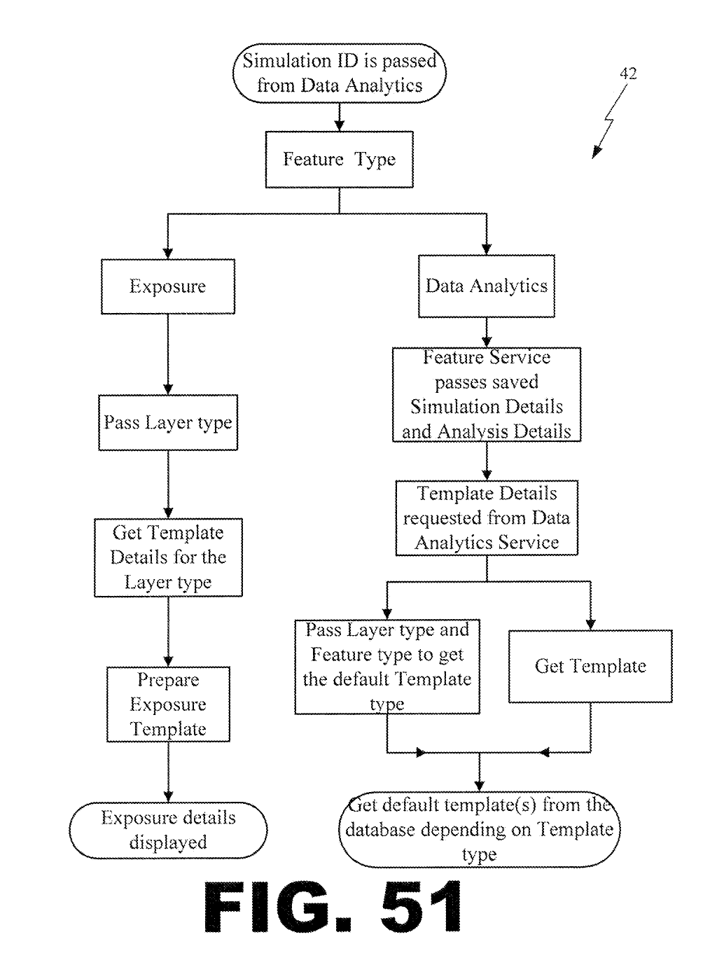

FIG. 51 is a flow diagram of the Template Service of the present invention illustrating one example of how the Data Analytics templates are retrieved. The Simulation type is passed from the Data Analytics Service which is then distinguished in the Template Service 42 depending on the type of application feature the user would like to see. If the feature is an Exposure, the Layer type is first passed to get template details for the Layer type. The Exposure Template is then prepared which displays the user configured Exposure data fields. If the feature is Data Analytics, the Feature Service passes the saved Simulation Details (Simulation type and Feature type) and Analysis Details (Analysis type, Simulation type, Layer type and Template type). The Template Service then requests Template Details from the Data Analytics Service. To obtain the Simulation Details, the Layer type and Feature type are passed to get the default templates the user created simulation. The Template Service 42 then gets the default Template(s) from the database depending on the Template type. To obtain Analysis Details, the Template Service 42 passes the Template type to get the Summary, Details and Details View templates. The Template Service 42 then gets the default template(s) from the database depending on the Template type and the Analysis Details are displayed. From the Feature Service, the Template Service 42 obtains saved Simulation Details (Simulation type and Feature type) and Analysis Details (Analysis type, Simulation type, Layer type and Template type).

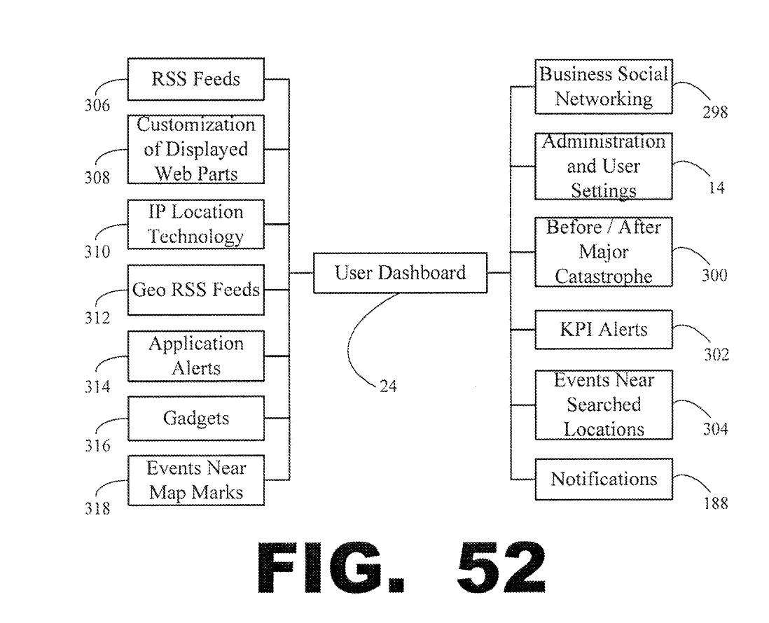

FIG. 52 is a chart outlining the features of the User Dashboard Module of the present invention. The user dashboard is a feature of the application which displays on the screen the user's settings, favorites and any specific actions the user has taken for quick reference such as saved model simulations. Within the User Dashboard module 24 are features the user may use.

A Business Social Networking 298 feature contains areas for social interaction or networking between multiple users. Shared folders exist for resources that are to be shared.

The Administration and User Settings 14 feature is a control panel interface that contains icons for the settings of different sections. The user may create, delete or modify settings according to user preference.

Snapshots of map images of regions that have endured a catastrophe are available in the Before/After Major Catastrophe 306 feature. An external data source for these images, a File Transfer Protocol (FTP) internet site, is used to import the images and geometry which is required.

A KPI alerts 302 the administrator that a specified input variable value has exceeded the limit. The user defines which alerts are received. Indicators exist for dynamic model damage, GeoRSS feeds and anything related to the portfolio.

The Events Near Searched Locations 304 feature allows the user to view or analyze events near a location that is searched. This feature uses external sources to crawl GeoRSS 312 and RSS 306 news events to bring up relevant data for areas that have been recently searched or map marked. When the user selects the data, the user is brought to the map with a marking or the article.

The Notifications 188 feature provides a summary of the notifications, such as the subscribers and subscriptions to the articles. The application displays dynamic hazard gadgets on the user dashboard on a daily basis.

Using the RSS Feeds 306 feature, the news or articles related to hazards or severe weather is further referenced. The administrator is able to customize the feeds to be received, by attributes of hazard, risk damage caused by hazard and other options. The type of hazards which will receive feeds may be chosen. The feeds have indications to its severity with respect to the policies nearby or affected policies.

The Customization of Displayed Web Parts 308 allows the user to customize the web parts to be displayed and how they are displayed.

The IP Location Technology for Nearest Events 310 feature shows the IP address for the nearest events. The user may search a database of IP locations and show relevant events that occurred in the areas collected from the GeoRSS 312 and RSS feeds 306.

News or articles on the geography that is going to be affected can be viewed via the GeoRSS Feeds 312 feature. The user may choose events source for GeoRSS 312 by either specifying the source manually or choosing from predefined system sources. Using this feature, the user may chose the types of events that are of interest, set layer's attributes to customize event layout on the map, view quick descriptions for the event, view the detailed information for the event on a source directly, automatically download detailed information which is then stored into an archive, receive notifications if the event happens, and provide basic information about GeoRSS source when selected.

The Application Alerts 314 feature alerts the user on where the peril may hit. An indicator within the Alerts feature alerts the user that a specified value has exceeded the limit or of any catastrophic events that have occurred. These alerts settings are configurable in the Administration and User Settings module. The Application Alerts feature has the ability to send alert messages to user via email or mobile devices for which the user is subscribed to.

A Gadgets 316 feature allows the user to download and install gadgets onto the user interface for personal and dashboard functionality.

The Events Near Map Marks 318 feature allows the user to view or analyze events near a location that is marked. The application highlights the nearest terror targets and policies for better analysis.

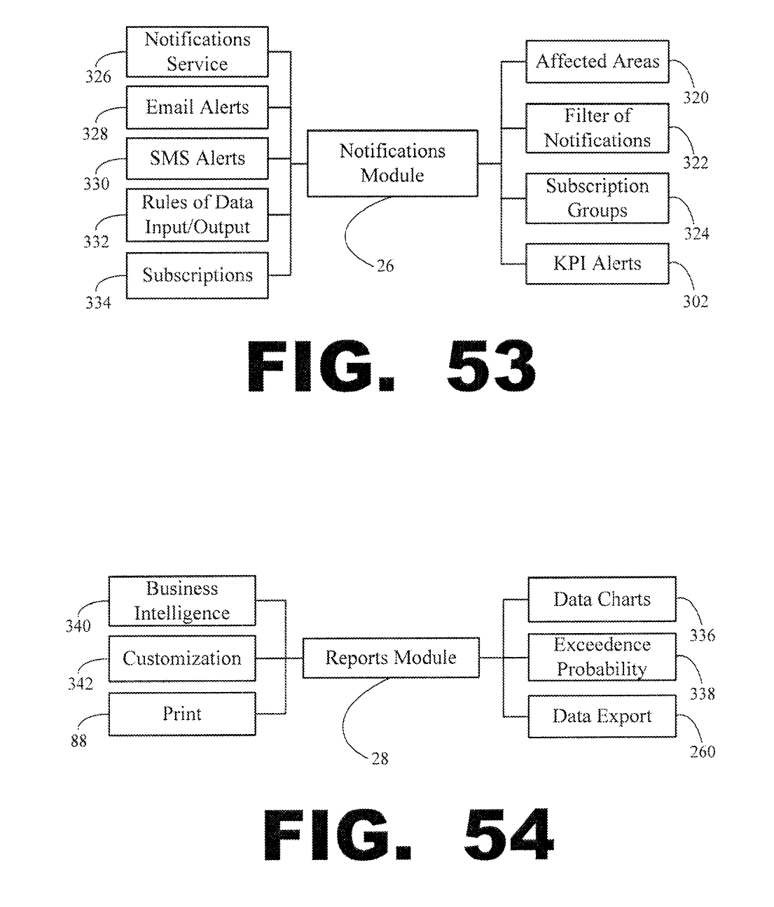

FIG. 53 is a chart outlining the features of the Notifications Module of the present invention. The Notifications Module 26 alerts the user of hazard event risk location damage based on criteria the user has selected. Based on configuration of the notifications, which are specific to every user, notification of areas affected by an event is specific to a set of attributes specified by the administrator. Areas that are being affected by severe weather containing the selected attributes may be notified through the Affected Areas 320 feature. The notifications may be filtered based on hazard attributes which are grouped as active or inactive. The administrator may create customized Subscription groups where users may be added and every user may belong to at least one group. The list of users belonging to each group may be viewed by the administrator. The user may subscribe and unsubscribe to KPI Alerts 302 in the application so that a notification is sent to them if there is a change in the severe weather which was predicted. Furthermore, the user is able to configure Rules of Data I/O 332 for the notifications. For example, in a dynamic hazard, the user may configure the subscription to notify the user only when wind speeds exceed 40 miles per hour (mph).

The Notifications Service 326 sends any type of notification, for which the user has configured, including emails 328 or Short Message Service (SMS) alerts 330 to the specified subscribers, for example, via a Simple Mail Transfer Protocol (SMTP) server.

FIG. 54 is a screenshot outlining the features of the Reports Module of the present invention. The Reports Module 28 provides the user with customization via easy to use UI's which allows users to build new data queries and immediately create Data Charts 336 for the results both graphically and numerically. This feature helps users drill down into data to determine reasons why certain data appears the way it does. An Exceedence Probability 338 curve graph functionality may be shown in the reports or on the user interface. These reports may be exported into a MICROSOFT EXCEL file. This allows the user to import user's own formulas into a spreadsheet as well as share the formulas with other users.

A graphical representation of information may be set. The user sees a list of all available plottable reports and may select the type of chart view.

The reports may be exported to different file types using a program such as ESKER or DANDAS to convert between certain formats (Hypertext Markup Language (HTML), Portable Document Format (PDF), Tagged Image File Format (TIFF), Comma Separated Values (CSV), EXCEL and so on).

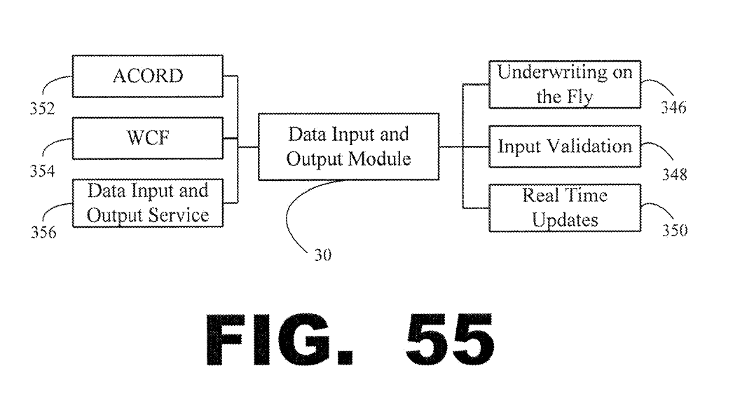

FIG. 55 is a chart outlining the features of the Data Input and Output Module of the present invention. The Data I/O module 30 allows the administrator to include new data or change data related to the portfolio. The Data I/O module 30 is a combination of smaller modules which allows inserting, updating and returning portfolio related data. The Data I/O Service 356 allows for importing and exporting of user data.

The administrator may utilize the Underwriting on the Fly 346 feature to add new business policies and modify information about policies for immediate use. For example, the administrator may use the manager to underwrite “What if” policies quickly. Once the data, or inputs, have been entered, Input Validation 348 occurs to allow the upload of Extensible Markup Language (XML) and XML Schema Document (XSD) files with data definition accepted. The validation of data being exported may occur by checking data type, size, required field, and data format.

This module allows user to update data in Real Time 350 in their application. The application downloads dynamic hazard information using real time sources like GeoRSS and has the portfolio exposure available via Data Analytics. Using this module, the user may perform an initial load of the entire portfolio and apply necessary modifications in the future.

The input and output of data follows the Association for Cooperative Operations Research and Development (ACORD) 352standards. This standard may be used to accept and communicate data from and to users. Data may be provided in either an XML format or web-service requests both in accordance with ACORD standards. While insurance companies following any standards may submit portfolio data, any ACORD compliant insurance company may submit data to the application with ease. The addition of information is secure and accurate using WCF 356.

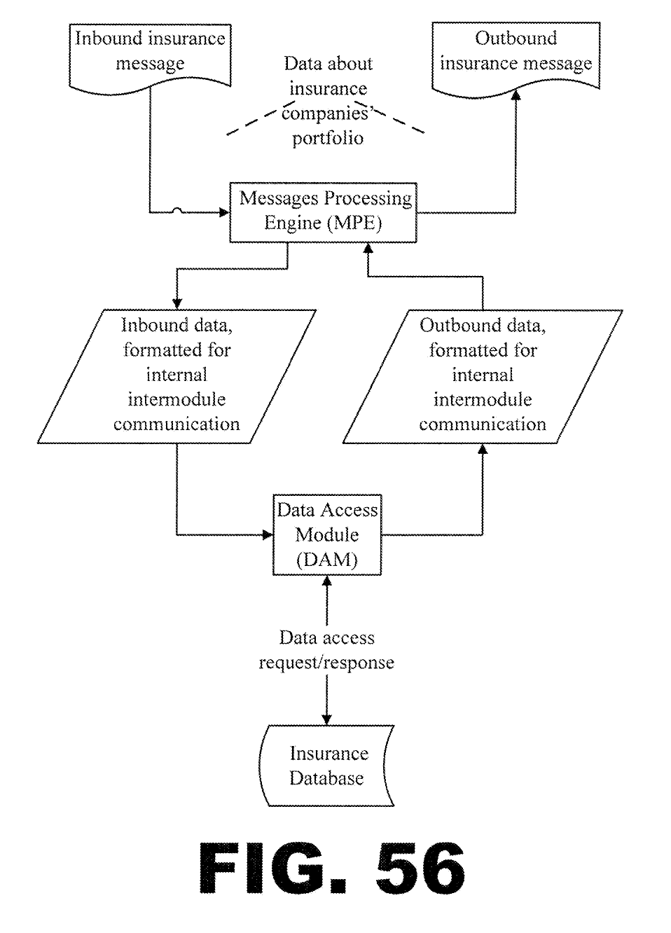

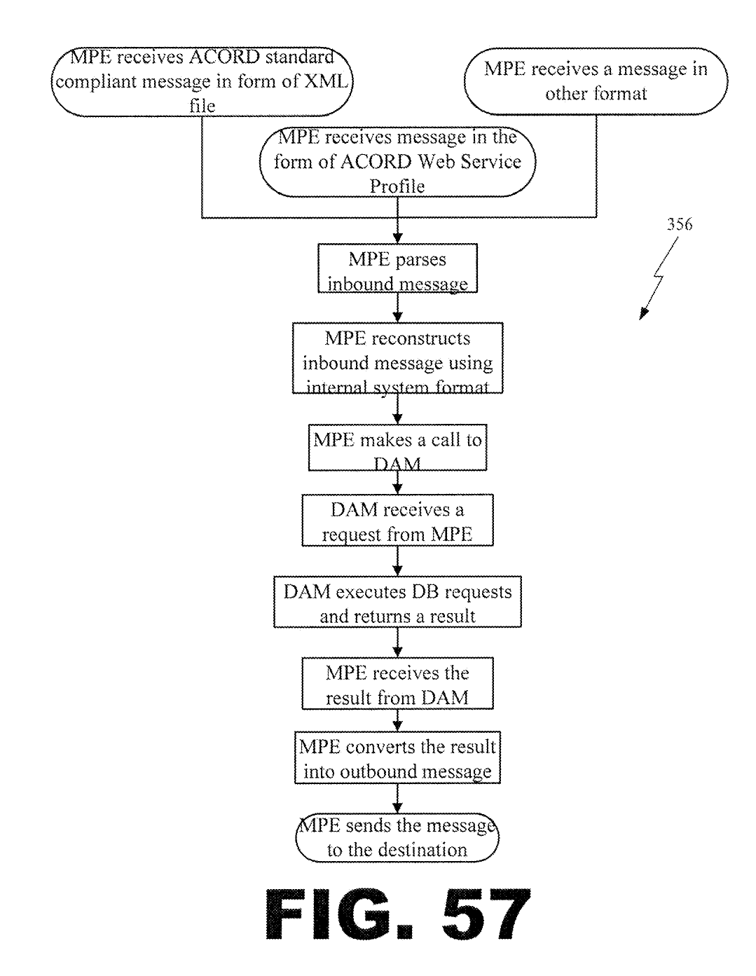

FIG. 56 is a flow diagram illustrating the inbound and outbound message format which may be used in the Data Input and Output Service. The inbound insurance message is primarily an ACORD XML standard compliant message use to add, modify, delete and retrieve information about risks in the user's portfolio. The outbound insurance message is used to communicate results in response to an inbound message. Also used is a Message Processing Engine for the purpose of receiving inbound messages of different formats and restructures them internally and transforms outbound messages from a system format into a desired structure understood by the user, abiding by a set of business rules. A Data Access Module is a set of WCF services which accepts inbound and generates outbound messages in the system's internal format and performs the requested data manipulation in the application database. An Insurance Database is a subset of the user's database which stores information about all insurance policies and all historical changes made to them.

FIG. 57 is a flow diagram illustrating one example of how the Data Input and Output Service may import and export data in the present invention. A Message Processing Engine parses and analyzes a data message to determine necessary attributes which are required for further processing. Message type may be one of those attributes. In accordance with the retrieved attributes, the Message Processing Engine transforms the inbound message into a system format. The Message Processing Engine then calls the Data Access Module which retrieves a request from the Message Processing Engine and calls required database modifications, if applicable, and returns a result to the Message Processing Engine. The Message Processing Engine then retrieves the resulting message from the Data Access Module and converts it in accordance with an inbound message form; if it is an export request, it will be in the export request specified format.

What is claimed is new and desired to be protected by Letters Patent and is set forth in the appended claims:

1. A method for rendering map layer images and providing information on an electronic medium comprising a means for interactive use in risk analysis applications.

2. The method for rendering map layer images and providing information on an electronic medium according to claim 1, further comprising:
a. logging into a browser by a user;
b. creating Map Tile requests by the browser;
c. sending created Map Tile requests from the browser to a Map Tile Manager;
d. sending the map for each Map Tile Manager to a Map Grid Controller;
e. dividing map requests into sub-requests by said Map Grid Controller;
f. preparing concurrent multi-threaded map requests by said Map Grid Controller;
g. sending said sub-requests to different Map Grid Nodes;
h. receiving map tile images from said Map Grid Nodes by said Map Grid Controller;
i. combining all map tile images by said Map Grid Controller;
j. sending the map tiles as a map image to said Map Tile Manager; and
k. displaying the map image.

3. The method for rendering map layer images and providing information on an electronic medium according to claim 2, wherein said map tiles contain map images and corresponding information for use in risk analysis applications.

4. The method for rendering map layer images and providing information on an electronic medium according to claim 2, further comprising an open layers framework having the ability to load map layers and information layers and loading the map layer and information layer images as tiles.

5. The method for rendering map layer images and providing information on an electronic medium according to claim 4, further comprising a means for providing information to an application.

6. The method for rendering map images and providing information on an electronic medium according to claim 1, further comprising a means for providing information requested for any layer in an application and any associated layers.

7. The method for rendering map images and providing information on an electronic medium according to claim 6, wherein said means further comprises returning data for user configured elements in an application.

8. The method for rendering map images and providing information on an electronic medium according to claim 7, wherein said means further comprises reading all layers from the available catalogs to which they are associated.

9. The method for rendering map images and providing information on an electronic medium according to claim 8, wherein said means provides information to an application associated with the map images and information layer images.

10. The method for rendering map images and providing information on an electronic medium according to claim 9 comprising:
a. selecting a tool from within an application to which the map images and information images are loaded;
b. requesting the desired list data;
c. querying of the data store; and
d. returning of the requested layer information for display.
